(19) United States
(12) Patent Application Publication
(10) Pub. No.: US 2025/0375264 A1
(43) Pub. Date: Dec. 11, 2025

(54) METHOD FOR DETERMINING AN ORTHODONTIC TREATMENT PLAN

(71) Applicant: DENTAL MONITORING, PARIS (FR)

(72) Inventors: Thomas PELLISSARD, Maisons-Alfort (FR); Guillaume GHYSELINCK, CANTIN (FR); Raphaël BRAHAMI, PARIS (FR)

(21) Appl. No.: 18/876,512

(22) PCT Filed: Jun. 22, 2023
(86) PCT No.: PCT/EP2023/067029

§ 371 Date: Dec. 18, 2024

(30) Foreign Application Priority Data
Jun. 22, 2022 (FR) FR2206189

(51) Int. Cl. A61C 7/00

(52) U.S. Cl. CPC A61C 7/002; A61C 2007/004

(57) ABSTRACT

A method for generating a plan for the orthodontic treatment of a user's dental arch, comprising the following consecutive steps: a) generating an initial model and a final model representing the dental arch at an initial moment and a final moment; b) determining, using a computer, a deformation scenario that transforms, through the movement of the tooth models, the initial model into the final model; c) determining, using the computer, —a duration for performing the deformation scenario; and —intermediate moments between the initial moment and the final moment for performing the deformation of the dental arch according to the deformation scenario.

### TECHNICAL FIELD

The present invention relates to a method for determining an orthodontic treatment plan, which includes determining a complete orthodontic treatment plan or part of a complete orthodontic treatment plan.

The invention also relates to a computer program and to a computer and system for implementing this method.

### PRIOR ART

An orthodontic treatment is intended to change the arrangement of a user's teeth by means of an orthodontic appliance.

Among orthodontic appliances, there are archwires and brackets on the one hand, and orthodontic aligners on the other.

An archwire-and-bracket orthodontic appliance comprises brackets that are attached to the teeth and connected to one another by means of an archwire, conventionally made of a shape-memory material. It exerts a rapid action on the movement of the teeth of the user undergoing treatment.

An aligner conventionally takes the form of a removable, one-piece appliance, conventionally made of a transparent polymer material. It comprises a channel shaped so that a plurality of teeth of an arch, generally all of the teeth of an arch, can be accommodated therein. The shape of the channel is suitable holding the aligner in position on the teeth while exerting a corrective action on the positioning of certain teeth. An orthodontic aligner has a slower initial action than an archwire-and-bracket orthodontic appliance. Advantageously, however, the aligner can be replaced by the user themself. In addition, aligners are more discreet than archwire-and-bracket appliances.

The implementation of orthodontic treatment requires the prior preparation of an orthodontic treatment plan in order to plan the steps in the orthodontic treatment to come. The orthodontic treatment plan thus defines moments at which a check of the dental arch by a dental practitioner and/or a modification of an orthodontic appliance, e.g. a change of orthodontic appliance, e.g. of orthodontic aligner, and/or a change of orthodontic archwire, and/or manufacture of an orthodontic appliance is/are planned.

Conventionally, an orthodontic treatment plan is drawn up by the dental practitioner using a computer. In particular, the computer allows them to visualize a model of a dental arch and to modify this model in order to determine any change in the position and orientation of each tooth, compatible with the change in the position and orientation of the other teeth, until the desired arrangement for all of the teeth of the arch is achieved. The dental practitioner is thus able to determine a series of digital three-dimensional models comprising a model representing said arch at the start of the orthodontic treatment, a model representing said arch at the end of the orthodontic treatment, and one or more “intermediate” models representing said arch at intermediate moments between the start and the end of the orthodontic treatment, the intermediate moments being moments at which a check of the arch by the dental practitioner and/or a modification of an orthodontic appliance and/or manufacture of an orthodontic appliance is/are planned. This series of models, or “deformation scenario”, and the intermediate moments thus define the orthodontic treatment plan.

Software for manipulating the model of the arch and generating an orthodontic treatment plan is well known. However, it is necessary to learn how such software works and orthodontic skills are required. Creating an orthodontic treatment plan can be laborious and time-consuming.

Furthermore, such software can lead to orthodontic treatment plans that result in rapid tooth movements, which are potentially harmful to the user's health.

There is an ongoing need for a method and a system that make it possible to improve the implementation of an orthodontic treatment plan.

One aim of the invention is to meet this need.

### DISCLOSURE OF THE INVENTION

### Summary of the Invention

According to a first main aspect, the invention provides a method for generating a plan for the orthodontic treatment of a user's dental arch, the method comprising the following consecutive steps:
a) generating or retrieving an “initial” model representing said dental arch in three dimensions at an initial moment, said initial model being divided into tooth models, and optionally a gum model, and
generating or retrieving a “final” model representing said dental arch with a “final” arrangement of the tooth models as desired at the end of the orthodontic treatment;
b) determining, using a computer, a set of consecutive elementary deformations that transform, through the movement of the tooth models, the initial model into the final model, said elementary deformations each observing a respective set of constraints, the models resulting from the consecutive elementary deformations being called “transition models”, the series of the set of consecutive transition models being called the “basic deformation scenario”;
c) determining, using a computer,
   a duration, called the “treatment duration”, for performing, from the initial moment, the deformation of the dental arch according to the basic deformation scenario until the final arrangement is obtained at a final moment; and
   intermediate moments between the initial and final moments for performing the deformation of the dental arch according to the basic deformation scenario, the intermediate moments being moments at which a check of the arch by a dental practitioner and/or a modification of an orthodontic appliance and/or manufacture of an orthodontic appliance is/are planned, the basic deformation scenario and said intermediate moments defining said orthodontic treatment plan, called the “basic orthodontic treatment plan”.

The moments at which the dental arch is expected to take a shape according to the transition models in the basic orthodontic treatment plan are called “transition moments”.

As will be seen in more detail later in the description, the computer creates the basic orthodontic treatment plan quickly and automatically, i.e. without human intervention, from the initial and final models alone. The automation of the creation of orthodontic treatment plans can be advantageously optimized, in particular with metaheuristic methods, thereby making it possible to reach levels of performance that are very difficult to reach manually, in particular avoiding collisions or ensuring the most regular possible, or fastest possible, tooth movements.

Preferably, a method according to the first main aspect of the invention also has one or more of the following optional features:
in step a), said computer determines the final model from the initial model;
in step a), to determine the final model, said computer
analyzes the shape of the initial model so as to determine the curvature and length of the dental arch, and to define a base line having said curvature and length, then,
for each of a plurality of tooth models, preferably for each tooth model of the initial model, determines a position and orientation of said tooth model relative to said base line, preferably from predefined rules and/or by matching the user's dental arch to a historical dental arch similar to the user's dental arch;
preferably, prior to step a), said predefined rules are determined via statistical processing of historical data;
in step b), said set of constraints comprises instruction constraints dictated by the user, preferably in order to specify the relative importance that the user gives to the speed of the orthodontic treatment, and/or the pain caused by orthodontic treatment, and/or comfort during the orthodontic treatment, and/or the cost of the orthodontic treatment, and/or the esthetic impact of the orthodontic treatment, and/or the reliability of the orthodontic treatment, i.e. the probability that the orthodontic treatment will lead to the expected result, and/or a duration for wearing an orthodontic appliance, and/or a predetermined functional, orthodontic or therapeutic objective;
in step b), the computer displays a dynamic form suitable for entering, preferably by the user, at least some of the information required to define said set of constraints, in particular those required to define instruction constraints;
in step b), said set of constraints allows limited penetration of a tooth model into an adjacent tooth model, the limitation of said penetration preferably being determined by the possibility, preferably evaluated according to the rules of orthodontics, preferably by a dental practitioner, of stripping, during the orthodontic treatment, at least one of the teeth modeled by said tooth models, in order to avoid a collision between said teeth resulting from said penetration;
in step b), the computer implements an optimization algorithm, preferably a first optimization algorithm to determine a basic deformation scenario that leads to a model that is as close as possible to the final model, and/or a second optimization algorithm to determine a basic deformation scenario that best meets one or more instructions dictated by the user;
in step b), the computer
searches for a “coarse” deformation scenario with a coarse initial model comprising fewer than 5000 points, preferably fewer than 2000 points, preferably fewer than 1000 points, preferably fewer than 500 points, preferably fewer than 100 points, and/or more than 50 points, the coarse initial model resulting from a simplification of a fine initial model comprising more points than the coarse initial model, preferably comprising 1.1, or 1.5 or 2 or 5 or 10 or 100 times more points than the coarse initial model, then
completes, at least partially, the transition and final models, i.e. adds points to these models,
determines whether, in the coarse deformation scenario in which the transition and final models have been completed in this way, tooth models collide in an unacceptable manner, and, in the event of an unacceptable collision, adds points to the coarse initial model, preferably at least in the collision zones, preferably at least the points added to the transition and final models in the collision zones, or even with all of the points added to the transition and final models, and
resumes said search with the coarse initial model to which the points have been added, cycling preferably being continued until a deformation scenario free of unacceptable collisions is obtained, constituting the base deformation scenario;
at the start of step c), the computer
determines, for each tooth model, the moment closest to the initial moment at which the tooth model can reach, by following the basic deformation scenario determined in step b), its configuration in the final model, or “end-of-path moment”;
determines, from among the set of tooth models, a tooth model that has the end-of-path moment farthest from the initial moment, or “limiting tooth model”;
sets the final moment as the end-of-path moment of the limiting tooth model;
the computer preferably determines the end-of-path moment of a tooth model, preferably of each tooth model, by dividing a distance representative of the movement of the tooth model during the basic deformation scenario by a speed representative of the kinetic capabilities of said tooth model;
in step c), the computer determines the intermediate moments by dividing said treatment duration according to the ability of one or more orthodontic appliances, preferably according to the ability of orthodontic aligners, to move the teeth modeled by the tooth models, and/or by dividing said treatment duration into intervals of equal duration, each interval preferably corresponding to a duration of use of an orthodontic aligner by the user intended for the orthodontic treatment, or corresponding to a frequency of checking that the orthodontic treatment is proceeding correctly, said frequency preferably being predetermined;
the method comprises, after step c), the following first step d):
d) determining, using the computer, a new deformation scenario called the “first smoothed deformation scenario”,
in which the configuration of the limiting tooth model is, at any intermediate moment, preferably at any transition moment, that defined by the basic deformation scenario determined in step b), and
in which a movement speed, preferably each movement speed, of at least one tooth model other than the limiting tooth model, or “slowed tooth model”, is smoothed between the initial moment and the final moment, i.e. in which at least one speed parameter is reduced or optimized, preferably minimized, the first smoothed deformation scenario and said intermediate moments defining a new orthodontic treatment plan, called the “first smoothed orthodontic treatment plan”;
the speed parameter is selected from among:
the largest value of a movement speed of said slowed tooth model reached between the initial and final moments, and/or
the difference between said largest value of said movement speed and the smallest value of said movement speed of said slowed tooth model between the initial and final moments, and/or
the variation in said movement speed of said slowed tooth model, averaged between the initial moment and the final moment;
the first smoothed deformation scenario is determined in such a way that the greatest value of said movement speed between the initial moment and the final moment is smaller than the greatest value of said movement speed between the initial moment and the final moment in the basic deformation scenario determined in step b);
the method comprises, after said first step d), one or more consecutive additional steps d), each additional step d) comprising determining, using the computer, an additional smoothed deformation scenario in which
the limiting tooth model follows the path defined by the basic deformation scenario determined in step b), and
the one or more slowed tooth models of the one or more steps d) prior to said additional step d) follow the one or more paths defined by said one or more smoothed deformation scenarios determined in said prior step d) or in said prior steps d), respectively,
the additional smoothed deformation scenario being determined so as to reduce or optimize, preferably minimize, said at least one speed parameter for at least one “additional” slowed tooth model, different from the one or more slowed tooth models of the one or more prior steps d), respectively, between the initial moment and the final moment, the orthodontic treatment plan thus modified being called the “additional smoothed orthodontic treatment plan”;
the slowed tooth model in the first step d) or when an additional step d) is selected according to a utility criterion for the dental practitioner and/or the user, preferably according to the risk to the user's health of applying the basic deformation scenario or the smoothed orthodontic treatment plan of the preceding step d), respectively;
the utility criterion defines a utility for limiting a risk to the user's health and/or for meeting instructions from the user;
the slowed tooth model in the first step d) or in an additional step d) is selected according to the risk to the user's health of applying a high movement speed, and in particular applying a movement speed corresponding to the highest physiologically acceptable movement speed for the slowed tooth that it models;
the closer an additional step d) is to step c), the higher said risk, i.e. the computer prioritizes the smoothing of the movement speeds of the tooth models for which rapid movement entails the highest risk;
preferably, the method comprises a step d) for each tooth model except the limiting tooth model;
the method comprises, after step c) and optionally after step d) or one or more additional steps d), the following step e):
e) designing and manufacturing at least one orthodontic appliance according to the basic orthodontic treatment plan obtained at the end of step c) or according to the smoothed orthodontic treatment plan obtained at the end of step d) or a cycle of steps d);
said orthodontic appliance is an orthodontic aligner and the intermediate moments are exclusively moments at which a change of orthodontic aligner is planned;
said orthodontic appliance is an orthodontic archwire and/or an auxiliary appliance, and the intermediate moments are exclusively moments at which a change of orthodontic archwire and/or of auxiliary appliance is planned;
said auxiliary appliance is selected from among a hook, a button, a cleat, an elastomer chain, a spring, an elastic band and a miniscrew;
said orthodontic appliance is an assembly comprising an orthodontic archwire and brackets for securing said archwire to the teeth, and the intermediate moments are exclusively moments at which a change of the archwire and/or of one or more brackets is planned;
the computer presents the basic orthodontic treatment plan and/or the smoothed orthodontic treatment plan to a dental practitioner for validation.

A complete orthodontic treatment conventionally comprises a plurality of phases. Each phase, or “partial orthodontic treatment”, can be the subject of an orthodontic treatment plan as per a method according to the invention, the initial model representing the dental arch at the start of the phase in question and the final model representing said dental arch with an arrangement of the tooth models as desired at the end of said phase.

The invention also relates to a method for generating a plan for the complete orthodontic treatment of a user's dental arch, the complete orthodontic treatment consisting of a series of a plurality of partial orthodontic treatments each corresponding to a respective phase of the complete orthodontic treatment, the method comprising the following consecutive steps:
A′) generating or retrieving a first “start-of-phase” model representing said dental arch at a moment at the start of the first phase of the complete orthodontic treatment, said first model being divided into tooth models, and generating or retrieving a last “end-of-phase” model representing said dental arch with an arrangement of the tooth models as desired at the end of the last phase of the complete orthodontic treatment, i.e. the end of the complete orthodontic treatment;
B′) determining, preferably using a computer or by a computer-assisted dental practitioner, for each phase, from the first phase to the penultimate phase, a respective end-of-phase model representing said dental arch with an arrangement of the tooth models as desired at the end of said phase;
C) for each phase, implementing a method comprising steps a) to c), and preferably a step d), preferably a cycle of steps d), the initial model being the model at the start of said phase and the final model being the model at the end of said phase.

The method implemented in step C′) can comprise one or more of the optional features described in this description.

The method for smoothing the speeds of the tooth models as described above can be generalized.

According to a second main aspect, the invention thus relates to a method for generating a plan for the partial or complete orthodontic treatment of a user's dental arch, the method comprising the following consecutive steps:
A) preferably following a step a),
   generating or retrieving an “initial” model representing said dental arch in three dimensions at an initial moment, said initial model being divided into tooth models, and
   generating or retrieving a “final” model representing said dental arch in three dimensions with a “final” arrangement of the tooth models as desired at a final moment marking the end of the partial or complete orthodontic treatment;
B) for each tooth model,
   determining a distance measuring a difference between the configurations of the tooth model in the initial model and in the final model;
   determining the shortest possible duration for the tooth model to travel said distance, i.e. determining the shortest movement duration to transition from the configuration of said tooth model in the initial model to the configuration of said tooth model in the final model, or “minimum movement duration”;
C) identifying the tooth model that has the longest minimum movement duration, or “limiting tooth model”;
D) determining a “first smoothed deformation scenario” according to which the initial model is transformed into the final model through the movement of the tooth models, the first smoothed deformation scenario being determined in such a way as to minimize, for at least a first “slowed” tooth model different from the limiting tooth model, a speed parameter selected from among:
   the largest value of a movement speed of said slowed tooth model reached between the initial and final moments, and/or
   a speed representative of the movement speed of said slowed tooth model, preferably a speed averaged between the initial moment and the final moment, and/or
   the difference between said largest value of said movement speed and the smallest value of said movement speed of said slowed tooth model between the initial and final moments, and/or
   the variation in said movement speed of said slowed tooth model, averaged between the initial moment and the final moment.

Preferably, intermediate moments are determined, preferably by the computer, preferably marking moments at which changes of orthodontic aligner are planned, the first smoothed deformation scenario and said intermediate moments defining a first smoothed orthodontic treatment plan.

The final model can be generated from the initial model by a dental practitioner using a computer suitable for manipulating tooth models.

In one embodiment, the distance measuring a difference between the configurations of the tooth model in the initial model and in the final model is determined without the need to have previously determined the arrangements of the teeth between the initial and final models, for example by comparing the initial and final models.

Preferably, however, in step B), a “basic deformation scenario” of said arch is determined, preferably by a computer, the basic deformation scenario comprising a series of intermediate models modeling said arch in three dimensions at intermediate moments between the initial moment and the final moment, said distance being determined according said basic deformation scenario, the distance being, for example, the distance traveled by one or more points of the tooth model according to the basic deformation scenario; then in step C), the limiting tooth model is determined, preferably by a computer, as the tooth model which, following the basic deformation scenario, has last reached its configuration in the final model.

The basic deformation scenario and the intermediate moments form a “basic orthodontic treatment plan”.

Smoothing can be achieved without necessarily having to define a basic deformation scenario, but the prior generation of a basic deformation scenario considerably improves the reliability or “predictability” of the orthodontic treatment plan, i.e. increases the probability that the teeth will move according to the orthodontic treatment plan.

In one embodiment, to determine the basic deformation scenario, the computer
determines a set of consecutive elementary deformations that transform the initial model into the final model through the movement of the tooth models, said elementary deformations each observing a respective set of constraints,
determines, for each tooth model, said distance according to said set of elementary deformations, said distance preferably being the sum of the elementary distances traveled by one or a plurality of points of the tooth model during the elementary deformations.

The basic deformation scenario and/or tooth model movement speeds can be determined by a dental practitioner using a computer suitable for manipulating tooth models, for example by means of the Treat software described on the page https://en.wikipedia.org/wiki/Clear_aligners#cite_note-invisalignsystem-10.

Alternatively, the basic deformation scenario can be determined in step b).

The movement speeds can be calculated from
distances measured by comparing the initial and final models and/or distances determined from the basic deformation scenario, preferably determined in step b), and
time intervals determined from the treatment duration, preferably determined according to step c).

The first smoothed deformation scenario preferably results from a modification of a basic deformation scenario. Such a method can advantageously be used to smooth a conventionally defined basic orthodontic treatment plan, in particular for an orthodontic treatment with a set of orthodontic aligners. Specifically, such a plan is conventionally defined manually by the dental practitioner, using a computer, by manipulating tooth models from an initial model to the final model.

The dental practitioner can also use software, such as Treat, to provide transition and intermediate models. The dental practitioner can then modify these models, with the software recalculating the intermediate moments accordingly.

Alternatively, smoothing can be performed on a basic deformation scenario determined autonomously by a computer, as described in the first main aspect of the invention.

Smoothing can be carried out autonomously by the computer.

Preferably, the first slowed tooth is, from among all of the teeth modeled in the initial model and with the exception of the limiting tooth modeled by the limiting tooth model, the tooth of the arch that it would be most useful to slow down, according to a utility criterion defined by the dental practitioner and/or the user and with regard to the basic orthodontic treatment plan.

The first slowed tooth can be the tooth of which the movement speed is the most critical to the user's health

The first slowed tooth can be, for example, the tooth of which a movement speed, according to the basic orthodontic treatment plan, reaches a value closest to a predetermined “acceptable” value, in particular a value beyond which an unacceptable risk arises for the user's health.

Preferably, a method according to the second main aspect of the invention also has one or more of the following optional features:
the intermediate moments, preferably determined by the computer, are moments at which a check of the arch by a dental practitioner and/or a modification of an orthodontic appliance and/or manufacture of an orthodontic appliance is/are planned, preferably moments at which a change of orthodontic aligner is planned;
the first slowed tooth is, from among all of the teeth modeled in the initial model and with the exception of the limiting tooth modeled by the limiting tooth model, the tooth of the arch of which the movement speed is the most critical for the user's health, for example the tooth of which a rapid movement entails the highest risk for the user;
the method comprises, after determining the first smoothed deformation scenario, determining, preferably using a computer, a second smoothed deformation scenario that reduces, preferably minimizes, the speed parameter for a second slowed tooth model, modeling a second slowed tooth, different from the limiting tooth model and the first slowed tooth model, preferably reducing, preferably minimizing, the greatest value of the movement speed reached between the initial moment and the final moment by said second slowed tooth model, with the constraint that the limiting tooth model and the first slowed tooth model follow the paths defined by the first smoothed deformation scenario;
preferably, the second slowed tooth is, from among all of the teeth modeled in the initial model and with the exception of the limiting tooth and the first slowed tooth, the tooth of the arch that it would be most useful to slow down, according to said utility criterion defined by the dental practitioner and/or the user and with regard to the first smoothed orthodontic treatment plan, preferably the tooth that leads to the lowest risk for the user's health, said utility criterion preferably being identical to the utility criterion used to select the first slowed tooth;
the second slowed tooth is the tooth of which a movement speed, according to the first smoothed orthodontic treatment plan, reaches a value closest to a predetermined “acceptable” value, in particular a critical value for the user's health;
the first smoothed deformation scenario, and optionally the second smoothed deformation scenario, is/are determined so as to observe:
anatomical constraints which preferably dictate that a tooth model not penetrate into an adjacent tooth model, and/or that the positions of one or more points of a tooth model be contained within a defined envelope around the tooth model, and/or that the translational speed of a tooth model in one direction be lower than an upper limit for a translational speed, and/or that the rotational speed of a tooth model about one axis and in one direction be lower than an upper limit for a rotational speed; and/or
clinical constraints dictated by the rules of orthodontics and/or the dental practitioner, preferably dictating immobility for one or more tooth models, and/or dictating technical constraints to be observed for moving a tooth model, and/or favoring some movements over others, and/or dictating an order for moving the tooth models, and/or dictating a correct occlusion, and/or allowing or prohibiting tooth stripping, i.e. allowing or prohibiting penetration of one tooth model into an adjacent tooth model, and/or allowing limited tooth stripping, i.e. limiting the degree of penetration of one tooth model into an adjacent tooth model, and/or allowing or prohibiting extraction of one or more teeth, and/or dictating a movement speed for one or more teeth; and/or
instruction constraints dictated by the user due, for example, to a need for an orthodontic treatment that causes limited pain and/or has a limited duration and/or has a limited cost, and/or has a limited esthetic impact and/or has minimal reliability, and/or entails a limited duration for the wearing of an orthodontic appliance, in particular a maximum duration for the wearing of an orthodontic aligner or archwire-and-bracket appliance, and/or has a limited number of steps, and in particular limits the number of orthodontic aligners required for the orthodontic treatment associated with the first smoothed deformation scenario, or optionally the second smoothed deformation scenario, and/or has a predetermined number of steps, and/or allows or prohibits tooth stripping, and/or allows limited tooth stripping, and/or allows or prohibits extraction of one or more teeth, and/or allows or prohibits the use of one or more auxiliary orthodontic appliances.

Generally speaking, the method preferably comprises determining, preferably using a computer, consecutively for each of the tooth models considered as a “slowed tooth model”, with the exception of the limiting tooth model, a smoothed deformation scenario (first smoothed deformation scenario for the first slowed tooth, second smoothed deformation scenario for the second slowed tooth, etc.), each time with the constraint that the limiting tooth model and the slowed tooth models according to the previously defined smoothed deformation scenarios follow the paths defined by said prior smoothed deformation scenarios.

According to a third main aspect, the invention relates to a method for entering information into a computer, in particular as part of a method for generating a plan for the orthodontic treatment of a dental arch, preferably according to the first or second main aspect of the invention, preferably at least for entering instruction constraints, said entry method comprising the following steps:
01) a first user enters a first item of information into the computer, for example into a first input field of a first form page displayed on a first screen of the computer;
02) the computer analyzes said first item of information, then prepares and displays, on a second screen of the computer, a second form page comprising a second input field presenting a request for a second user to enter a second item of information, whether or not the second input field is displayed and/or the nature of the second item of information accepted by the second input field depending on the first item of information entered by the first user in the preceding step;
03) the second user enters the second item of information into the computer using the second input field,
04) preferably, the computer uses the second item of information and preferably the first item of information to define an orthodontic treatment plan and/or to monitor the progress of an orthodontic treatment.

The second form page, used to enter the second item of information, may be a new page or may have been adapted from the first page used in step 01) to enter the first item of information.

According to the invention, it belongs to a dynamic form.

As will be seen in more detail later in the description, a dynamic form comprising one or more said pages advantageously allows much more efficient input than a static form. Specifically, it avoids input pages unsuited to the second user having to be read unnecessarily. A dynamic form therefore speeds up input by the second user. By making it easier to understand the situation, it also reduces the risk of incorrect input.

A dynamic form guides input closely, advantageously allowing input without assistance, in particular without the dental practitioner. In particular, input can takes place remotely from the dental practitioner, in particular using the first and/or second user's cellphone. For example, if several photos have to be acquired under different acquisition conditions, the form can ask for the first photo to be captured, and only ask for the second photo to be captured once the first photo has been analyzed and validated.

The dynamic form is particularly useful when the computer is integrated into a cellphone. Specifically, it limits information exchanges with the cellphone.

The second form page may result from a refresh of the first form page, or may be a new form page, in particular when the first form page does not belong to the same form as the second form page, for example when the first form page was displayed more than one hour before the second form page.

The first user may be identical to the second user, and in particular be an individual for whom orthodontic treatment is underway or is to be planned. The first and second screens are then preferably identical. They may be the screen of the user's cellphone, for example.

The first user may be different from the second user. In particular, the first user may be a dental practitioner and the second user may be a private individual for whom orthodontic treatment is underway or is to be planned. The first and second screens are then preferably different. They may be, for example, the screen of a PC at the dental practitioner's practice and the screen of the user's cellphone, respectively. This embodiment advantageously allows the first user to enter “professional” information which the second user is unable to determine on their own. For example, a dental practitioner may analyze the individual's dental situation, for example by analyzing photos of the individual's mouth that the latter has transmitted to them via their phone, and enter data characterizing this dental situation. The individual then has access to a form specifically suited to their dental situation. More generally, this embodiment allows each user to enter information that the other user does not know, with the input interface for one user depending on the inputs entered by the other user.

Preferably, a method according to the third main aspect of the invention also has one or more of the following optional features:
the second input field accepts a second item of information only if it meets a criterion, for example if it belongs to a predefined range or a predefined list, said criterion depending on the first item of information;
the format of the second input field depends on the first item of information;
the first item of information comprises at least one photo, preferably at least one photo with the mouth closed and at least one photo and/or at least one panoramic and/or cephalometric X-ray with the mouth open, preferably at least one photo with the mouth closed, at least one photo with the mouth open, at least one front-view photo, at least one right-view photo and at least one left-view photo, the right and left being relative to the first user;
the computer analyzes said one or more photos and, depending on the result of said analysis, displays or does not display the second input field and/or determines the nature of the second item of information accepted by the second input field;
as soon as the first user has entered the first item of information, the computer analyzes said first item of information and adapts the page displayed accordingly;
the first item of information is entered less than 10 minutes before the second form page is displayed;
the first item of information and/or the second item of information is a instruction dictated by the first and/or second user expressing a need for an orthodontic treatment to be planned that causes limited pain and/or has a limited duration and/or has a limited cost, and/or has a limited aesthetic impact and/or has minimal reliability, and/or entails a limited duration for the wearing of an orthodontic appliance, and/or achieves a predetermined functional, orthodontic or therapeutic goal, in particular to define constraints for the creation of an orthodontic treatment plan according to the first and/or second main aspects of the invention.

Preferably, only those input fields for which input is required are displayed. In other words, if an input is not always necessary, the computer queries the first user to determine whether the corresponding input field should be displayed.

For example, if the possibility of benefiting from anesthesia depends on the second user's medical history, before displaying a second input field for the second user for entering their consent or otherwise for anesthesia, the computer can display input fields for the first user to specify whether the second user has already had reactions to anesthesia, and display a second input field for the second user for entering their consent or otherwise for anesthesia only if the answer is negative.

In addition to one or more input fields, a form page conventionally comprises navigation buttons allowing the previous or next page of the form to be displayed, or for exiting the form.

The first and/or second item of information may be of any type, and in particular may be photos of said dental arch, X-ray images of said dental arch, data on planned or current orthodontic treatment, models of said dental arch or views of models of said dental arch, or clinical instructions.

The first and/or second item of information may comprise information on the first and/or second user, such as data on the age or gender of the first user.

Preferably, the information comprises photos, preferably extraoral photos, of at least one arch of the first user, preferably in the form of a film. Preferably, the photos comprises at least one open-mouth image and at least one open-mouth image. Preferably, the photos comprise at least one front-view photo, one right-view photo and one left-view photo, the right and left being relative to the user.

Preferably, the first and/or second item of information comprises a clinical instruction defining a number of teeth to be moved and the number of the teeth to be moved and/or kept immobile.

Preferably, the first and/or second item of information comprises a definition of treatment goals and/or a definition of a maximum number of orthodontic aligners for an orthodontic treatment to be planned.

The computer preferably comprises a memory defining a set of conditional rules determining the second input field, directly or indirectly according to the first item of information.

A conditional rule determining the second input field for the second item of information directly according to the first item of information is, for example, “if the first user has entered an age below 12, display the second input field asking whether the first user has lost their milk teeth”.

Conditional rules determining the second input field indirectly according to the first information are, for example, “if analysis of a photo of the first user's dental arch reveals the presence of tartar, display the second input field requesting the date on which the first user underwent scaling”. Specifically, the photo constituting the first item of information needs to be analyzed in order to determine the presence of tartar. The second input field is displayed only if the analysis results in the detection of tartar.

Preferably, the conditional rules also determine how the second input field is presented, and more generally how the objects on the page featuring the second input field are presented. For example, presentation may differ depending the age of the first user.

The conditional rules can be ordered in the form of a decision tree.

In one embodiment, the method comprises, for each first item of information of a set of first items of information, a cycle of steps 01) to 03), said set of first items of information preferably comprising more than 10, more than 50, more than 100 and/or fewer than 1000 first items of information, whether or not the input field of a step 02) of such a cycle is displayed and/or the nature of the second item of information accepted by the input field of a step 02) of such a cycle depending not only on the first item of information entered by the user in step 01) of said cycle but also on at least one first item of information and/or at least one second item of information entered in one or more previous cycles.

The method preferably comprises a single step 04).

There is no restriction on the form of the second input field.

Insofar as a feature according one aspect of the invention is technically compatible with another main aspect of the invention, it can be applied to this other aspect of the invention.

In particular, the features related to smoothing as described according to the first main aspect of the invention are potentially applicable to the second main aspect, and vice versa. In particular, certain terms such as “basic deformation scenario” or “first smoothed deformation scenario” are used in the description of both main aspects because they refer to similar objects, and potentially to the same objects when both main aspects apply. For these objects in particular, the features according to the first main aspect of the invention are potentially applicable to the second main aspect, and vice versa.

The invention further relates to:
a computer program comprising program code instructions for executing
steps b) and c), preferably steps a), b) and c), and optionally the first step d) and preferably additional steps d), and preferably an operation of designing an orthodontic appliance for a step e) and/or
a step C′) and preferably a step A′) or B′), and preferably a step A′) and a step B′) and a step C′), and/or
a step 02), i.e. for displaying a dynamic form according to the invention, and preferably for entering the first item of information, and/or
steps B), C) and D), and preferably A),
   when said program is executed by said computer;
a data medium on which such a program is recorded, for example a memory or a CD-ROM, and
a computer into which such a product is loaded,
an assembly comprising such a computer and an apparatus for manufacturing an orthodontic appliance for implementing a step e).

Preferably, the computer program comprises program code instructions for automating all of the operations that can be automated.

Preferably, the computer program further comprises program code instructions for dividing the initial model into tooth models and/or determining the final model from the initial model.

The invention also relates to a system comprising
a three-dimensional scanner capable of producing a “rough” model of the arch of the first user, and
a computer according to the invention, preferably optionally configured to transform said rough model into an initial model, optionally with the assistance of a dental practitioner.

### Definitions

The term “user” means any person for whom a method according to the invention is implemented, whether or not that person is ill.

The term “dental practitioner” means any practitioner dealing with teeth in the broadest sense, including orthodontists and dentists in particular.

A “complete orthodontic treatment” is a treatment intended to correct the arrangement of the teeth in a dental arch to reach a definitive position desired by the user. An orthodontic treatment that is part of a complete orthodontic treatment is referred to as “partial”. Without further clarification, an “orthodontic treatment” refers generically to a complete or partial orthodontic treatment.

An orthodontic treatment requires the use of one or more orthodontic appliances. An orthodontic treatment intended to keep the teeth in a definitive position is not considered to be an orthodontic treatment in the present case.

An orthodontic treatment is planned using a “treatment plan”. A distinction is thus made between the “orthodontic treatment”, which refers to a series of operations that take place in reality, and the “treatment plan”, which is the result of designing the orthodontic treatment. The treatment plan therefore comes prior to the corresponding orthodontic treatment.

An orthodontic treatment by means of orthodontic aligners is the implementation of a treatment plan that defines models for the dental arch in shapes that are anticipated, prior to the orthodontic treatment, for different moments during the orthodontic treatment. Generating a treatment plan conventionally includes designing one or more orthodontic aligners and modeling them. An example of aligner design is described in “History of Orthodontics” by Basavaraj Subhashchandra Phulari. The treatment plan thus defines models for the orthodontic aligners that are implemented, and these models are used to manufacture the corresponding orthodontic aligners. Orthodontic aligners can be modeled automatically, using a computer, or manually, in the conventional manner, by a dental practitioner.

More precisely, a series of models of the user's arch, which represent consecutive arch configurations, and a corresponding series of models of orthodontic aligners, are conventionally determined, allowing orthodontic aligners to be manufactured that are each designed to modify the configuration of the arch from one configuration represented by one arch model to the configuration represented by the next arch model.

Each treatment plan therefore “corresponds” to an orthodontic treatment, to models of the arch at the start and end of the associated orthodontic treatment, and, if the orthodontic treatment is implemented, one or more orthodontic aligners designed to achieve a dental arch configuration in accordance with the model of the dental arch at the end of the orthodontic treatment.

One example of software for manipulating tooth models and creating a treatment plan is the Treat program, described on the page https://en.wikipedia.org/wiki/Clear_aligners#cite_note-invisalignsystem-10. U.S. Pat. No. 5,975,893A also describes the creation of a treatment plan.

An “orthodontic appliance” is an appliance suitable for the implementation of an orthodontic treatment. Orthodontic appliances can be used for therapeutic or prophylactic treatment, as well as for esthetic purposes.

An orthodontic appliance can be, in particular, an arch-and-bracket appliance, or an orthodontic aligner, or an auxiliary appliance of the Carrière Motion type. The configuration of an orthodontic appliance can be determined, in particular, to ensure the attachment thereof to the teeth, but also according to a desired positioning for the teeth. More precisely, the shape is determined in such a way that, in the position of use, the orthodontic appliance exerts stresses that urge the treated teeth toward their desired positions.

A 3D scanner, or “scanner”, is a device that produces a model of a dental arch.

The “position of use” is the position of an orthodontic appliance, such as an orthodontic aligner, once it has been attached to the arch in order to treat that arch. Conventionally, an orthodontic aligner can be removed by the user by simply pulling on the aligner.

The term “computer” means a computer processing unit, which includes a set of several machines with computer processing capabilities. In particular, this unit can be integrated into a scanner or into a cellphone, or be a PC-type computer or server, for example a server remote from the user, e.g. being the “cloud” or a computer located at a dental practitioner's practice.

Conventionally, a computer comprises a processor, a memory, a human-machine interface, conventionally comprising a screen, and a communication module for communication via the Internet, Wi-Fi, Bluetooth® or the phone network. A computer program configured to implement, at least partially, a method of the invention is loaded into the computer's memory. The computer can also be connected to a printer.

In a method according to the invention, different computers in communication with one another can be used for different steps or, preferably, the same computer is used for all steps. The computer is preferably integrated into a cellphone.

The term “computer form” means a set of pages, i.e. made up of one or more pages, which are displayed on a computer screen and allow the user to enter information.

A form is “dynamic” when it adapts according to information on the user acquired previously on the displayed page or on previously displayed pages, for example by means of the dynamic form. It is therefore not predefined as a static questionnaire that asks for the same information, in the same way, regardless of the information previously entered, in particular by the user.

An “input field” is an area of a form page used for the user to enter information into the computer. An input field can be, for example:
a multiple-choice question, e.g. with checkboxes;
an input area for text or numbers;
a cursor to be moved;
a button to click;
an ordered set of buttons and/or checkboxes and/or selectable elements, for example a “teeth map”, as shown in FIG. 8.

The adjectives “first” and “second” are used to distinguish the input fields on the first and second form pages. The first and second input fields may be different or identical, for example if the first item of information leads only to a change in the appearance of the first input field.

The term “model” means a three-dimensional digital model. A model is made up of a set of voxels or “points”. A model can be a .stl or .Obj, .DXF 3D, IGES, STEP, VDA or point cloud, for example. Advantageously, such a “3D” model can be viewed from any angle.

An “arch model” is a three-dimensional digital model that represents an arrangement of a user's teeth. Preferably, the arch model also represents other organs of the mouth, in particular the gums.

There is no restriction on the number of points in an arch model. In one embodiment, an arch model, and in particular a final model, comprises only those points that are strictly necessary to define the arrangement of the teeth.

A “tooth model” is a three-dimensional digital model of a tooth in a user's arch. An arch model can be cut to define tooth models for at least some, preferably all, of the teeth represented in the arch model. Tooth models are therefore models within the arch model. FIG. 3 shows an exemplary view of an arch model divided into tooth models 32, with only the tooth models shown. Computer tools are available to manipulate tooth models in an arch model. These tools allow constraints to be dictated, in particular to limit tooth model movements to realistic movements, for example to prevent adjacent tooth models from interpenetrating.

There is no restriction on the number of points in a tooth model. In one embodiment, a tooth model comprises only those points that are strictly necessary to define its configuration. In one embodiment, it comprises points that may collide with other tooth models.

A point of a tooth model of the initial model is “in correspondence” with a point of a tooth model of the final model (or of a transition model) if the deformation scenario changes the position of the point of the tooth model of the initial model so that it substantially merges with that of the point of the tooth model of the final model at the final moment (or of the transition model at the transition moment).

According to the international convention of the FDI World Dental Federation, each tooth in a dental arch, and therefore each tooth model, has a predetermined “tooth number”. The tooth numbers defined by this convention are shown in FIG. 4.

A “noteworthy point” is a point on an arch or tooth model that can be identified, e.g. the tip of the tooth or at the tip of a cusp, a point of interdental contact, that is, of a tooth with an adjacent tooth, e.g. a mesial or distal point of the incisal edge of a tooth, or a point at the center of the tooth crown, or “barycenter”.

The “division” of an arch model into “tooth models” is an operation that delimits and makes autonomous the representations of the teeth (tooth models) in the arch model. Computer tools are available to manipulate tooth models in an arch model. One example of software for manipulating tooth models is the Treat program, described on the page https://en.wikipedia.org/wiki/Clear_aligners#cite_note-invisalignsystem-10.

Once an arch model has been divided into tooth models, it is also possible to divide other models, such as a gum model.

The function of a “reference frame” is to act as a basis for locating points in space, in particular for measuring a distance, or for measuring an orientation or position, for example of a tooth model. A reference frame can be, for example, a three-dimensional, orthonormal reference frame. To determine an arrangement of teeth in an arch model or a configuration of a tooth in the arch, a fixed reference frame is used in relation to the arch model. The reference frame can, for example, have its origin at the center of the user's oral cavity.

The “configuration” of a tooth or tooth model refers to its position and orientation in the reference frame.

A “deformation scenario” is a set of chronologically ordered transition models. It is therefore the sequence of the transition models. It can be seen as a kind of 3D movie showing how the arch model deforms in the space between the initial model and the final model.

The “breakdown” of a deformation scenario consists in defining the intermediate moments, i.e. specifying the moments at which, when the deformation scenario takes place, a check of the dental arch by a dental practitioner and/or a modification of an orthodontic appliance, in particular a change of orthodontic aligner for an orthodontic treatment with orthodontic aligners, and/or manufacture of an orthodontic appliance, will have to be carried out.

An “orthodontic treatment plan” comprises a deformation scenario and the intermediate moments defined for this deformation scenario.

A “step” is a period in the orthodontic treatment plan defined between the initial moment and the first intermediate moment, between two consecutive intermediate moments or between the last intermediate moment and the final moment.

A phase can typically comprise between 2 and 150 steps. For example, to correct drift after an orthodontic treatment to correct a malocclusion, or “relapse”, two or three orthodontic aligners may be sufficient. A phase of correcting a complex malocclusion may require dozens of orthodontic aligners.

The “path” of a tooth model through a deformation scenario is the set of consecutive representations of the tooth model in the transition models of the deformation scenario. It can be seen as a kind of 3D movie showing how the tooth model moves in space, in translation and/or rotation, between the initial moment and the final moment. Determining a deformation scenario by moving the tooth models thus comprises finding a set of paths for the models of the teeth in the arch.

The “kinetic capabilities” of a tooth model define the highest physiologically acceptable values for the movement speeds of that tooth model.

The highest physiologically acceptable value for a tooth model speed is therefore a speed above which there is a risk to the user's health, e.g. a risk of the tooth coming loose. It depends on the nature of the tooth, or the tooth number. For example, an incisor tolerates higher movement speeds than a molar.

A higher physiologically acceptable value for a tooth model speed can be defined according to the number of the tooth being modeled, in particular on the basis of statistical data. It can also depend on the user, for example to take account of the presence of cleats.

A higher physiologically acceptable value for a speed also depends on the type of movement in question, e.g. rotation or translation, and on the direction of the movement in question, e.g. extrusion or intrusion. Preferably, higher physiologically acceptable values are therefore defined for multiple movement speeds.

The “movement speeds” of a tooth model comprise a translational speed, for example the modulus of the velocity vector, and a rotational speed.

To take account of the differing behavior of a tooth depending on the type of movement, the movement speeds can comprise:
the translational speeds, along the various axes of a reference frame that is fixed relative to the model of the arch, of a point linked to the tooth model, preferably the barycenter of the tooth model, and
the rotational speeds of the tooth model around each of said axes.

To take account of the differing behavior of a tooth depending on the direction of movement, the movement speeds can also comprise said translational and rotational speeds, distinguishing the direction of the speed in each case, for example to distinguish between extrusion and intrusion.

A movement speed for a tooth model corresponds to an anticipated movement speed for the modeled tooth according to an orthodontic treatment plan.

A deformation scenario is “smoothed” when a speed parameter is reduced, preferably minimized, which parameter is preferably selected from among:
the largest value of a movement speed of said slowed tooth model reached between the initial and final moments, and/or
a speed representative of the movement speed of said slowed tooth model, preferably a speed averaged between the initial moment and the final moment, and/or
the difference between said largest value of said movement speed and the smallest value of said movement speed of said slowed tooth model between the initial and final moments, and/or
the variation in said movement speed of said slowed tooth model, averaged between the initial moment and the final moment.

A “representative speed” of a tooth model is a speed determined from one or more movement speeds of said tooth model, for example the modulus of the translational velocity vector of the barycenter of the tooth model, or of the rotational velocity vector of a noteworthy point on the surface of the tooth model.

A “representative distance” for the movement of a tooth model is a distance calculated from the movement of one or more points on the tooth model and/or one or more points linked to the tooth model, such as its barycenter. One example of a representative distance is the length of the path traveled by the barycenter of a tooth model following a deformation scenario. Another example of a representative distance is the Euclidean distance between the position of the barycenter of a tooth model in the final model and in the initial model.

A “correct occlusion” is an arrangement of the teeth in the two dental arches that allows the two arches to come into contact with one another in a way that is acceptable according to the rules of orthodontics. In particular, with a correct occlusion, the cusps of the teeth in the upper arch are not in contact with the cusps of the teeth in the lower arch when the mouth is closed. The teeth of the two arches “interlock”, with the cusps of the teeth in one arch entering the grooves or interdental spaces of the teeth in the other arch.

An “image” refers to a two-dimensional image, such as a photograph or a video frame. An image is made up of pixels.

The terms “image of an arch”, “view of an arch”, “representation of an arch”, “scan of an arch”, or “model of an arch” mean an image, view, representation, scan or model of all or part of said dental arch, preferably representing at least two, preferably at least three, preferably at least four teeth. FIG. 2 shows an exemplary view of an arch model comprising 5000 points.

“Metaheuristic” methods are well-known optimization methods. They are preferably selected from the group formed by
evolutionary algorithms, preferably selected from among evolution strategies, genetic algorithms, differential evolution algorithms, estimation of distribution algorithms, artificial immune systems, Shuffled Complex Evolution path relinking, simulated annealing, ant colony algorithms, particle swarm optimization algorithms, Tabu search, and the GRASP method;
the kangaroo algorithm, the Fletcher-Powell method, the noise method, stochastic tunneling, random-restart hill climbing, the cross-entropy method, and
hybrid methods between the above-mentioned metaheuristic methods.

A “statistical treatment” is one which, when applied to a set of “historical” data, makes it possible to determine characteristics specific to this set, such as a mean, a standard deviation, or a median value. Statistical processing tools are well known to the person skilled in the art.

“Deep learning algorithms” are also well known to the person skilled in the art. They comprise “neural networks” or “artificial neural networks”.

The person skilled in the art knows how to select and train a neural network according to the task in hand. In particular, a neural network can be selected from among:
networks specialized in image classification, called “CNN” (“Convolutional neural network”), e.g. AlexNet (2012), ZF Net (2013), VGG Net (2014), GoogleNet (2015), Microsoft ResNet (2015), Caffe: BAIR Reference CaffeNet, BAIR AlexNet, Torch1: VGG_CNN_S, VGG_CNN_M, VGG_CNN_M_2048, VGG_CNN_M_1024, VGG_CNN_M_128, VGG_CNN_F, VGG ILSVRC-2014 16-layer, VGG ILSVRC-2014 19-layer, Network-in-Network (Imagenet & CIFAR-10), Google: Inception (V3, V4),
networks specializing in locating and detecting objects in an image, called Object Detection Networks, e.g. R-CNN (2013), SSD (Single Shot MultiBox Detector: Object Detection network), Faster R-CNN (Faster Region-based Convolutional Network method: Object Detection network), Faster R-CNN (2015), SSD (2015), RCF (Richer Convolutional Features for Edge Detection) (2017), SPP-Net, 2014, OverFeat (Sermanet et al.), 2013, GoogleNet (Szegedy et al.), 2015, VGGNet (Simonyan and Zisserman), 2014, R-CNN (Girshick et al.), 2014, Fast R-CNN (Girshick et al.), 2015, ResNet (He et al.), 2016, Faster R-CNN (Ren et al.), 2016, FPN (Lin et al.), 2016, YOLO (Redmon et al.), 2016, SSD (Liu et al.), 2016, ResNet v2 (He et al.), 2016, R-FCN (Dai et al.), 2016, ResNeXt (Lin et al.), 2017, DenseNet (Huang et al.), 2017, DPN (Chen et al.), 2017, YOLO9000 (Redmon and Farhadi), 2017, Hourglass (Newell et al.), 2016, MobileNet (Howard et al.), 2017, DCN (Dai et al.), 2017, RetinaNet (Lin et al.), 2017, Mask R-CNN (He et al.), 2017, RefineDet (Zhang et al.), 2018, Cascade RCNN (Cai et al.), 2018, NASNet (Zoph et al.), 2019, CornerNet (Law and Deng), 2018, FSAF (Zhu et al.), 2019, SENet (Hu et al.), 2018, ExtremeNet (Zhou et al.), 2019, NAS-FPN (Ghiasi et al.), 2019, Detnas (Chen et al.), 2019, FCOS (Tian et al.), 2019, CenterNet (Duan et al.), 2019, EfficientNet (Tan and Le), 2019, AlexNet (Krizhevsky et al.), 2012
networks specializing in image generation, e.g. Cycle-Consistent Adversarial Networks (2017), Augmented CycleGAN (2018), Deep Photo Style Transfer (2017), FastPhotoStyle (2018), pix2pix (2017), Style-Based Generator Architecture for GANs (2018), SRGAN (2018).

The above list is not exhaustive.

Training a neural network consists in improving it with a training base containing information on the two types of object that the neural network must learn to “match”, that is, connect to one another.

Training can be based on a learning base made up of records, each comprising a first object of a first type and a corresponding second object of a second type.

Alternatively, training can be carried out using a learning base made up of records, each of which contains either a first object of a first type, or a second object of a second type, but each record contains information relating to the type of object it contains. Such training techniques are described, for example, in the article by Zhu, Jun-Yan, et al. “Unpaired image-to-image translation using cycle-consistent adversarial networks”

Training the neural network with these records teaches it to provide, from any object of the first type, a corresponding object of the second type.

The quality of the analysis performed by the neural network depends directly on the number of records in the training database. Preferably, the learning base comprises more than 10,000 records and/or fewer than 10,000,000 records.

“Comprise”, “include” and “have” are to be interpreted broadly and without limitation, unless otherwise specified.

### BRIEF DESCRIPTION OF THE FIGURES

Further features and advantages of the invention will become apparent from the following detailed description and from examining the accompanying drawing, in which:

FIG. 1 schematically illustrates a method according to the first main aspect of the invention;

FIG. 2 shows an example of a model acquired using a portable scanner integrated into a cellphone and comprising 5000 points;

FIG. 3 shows an example of an arch model divided into tooth models, which bear the reference 32 (only the tooth models are shown);

FIG. 4 shows the tooth numbering used in dentistry;

FIG. 5 schematically illustrates a method according to the second main aspect of the invention;

FIG. 6 schematically illustrates a form page for a method according to the third main aspect of the invention;

FIG. 7 schematically illustrates a method according to the third main aspect of the invention;

FIG. 8 shows an example of a teeth map that can be used in a dynamic form according to the invention.

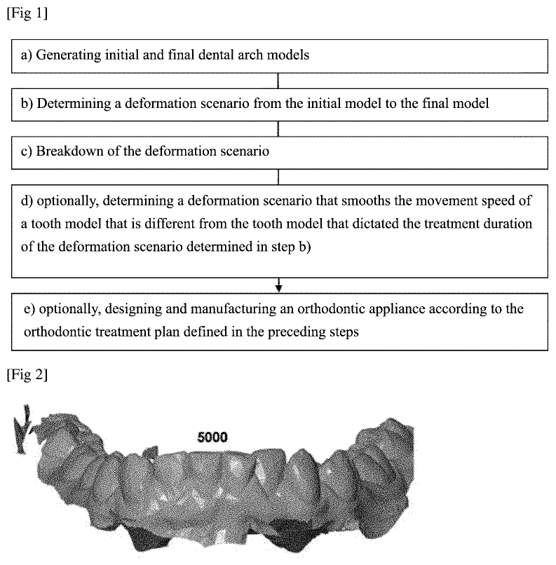

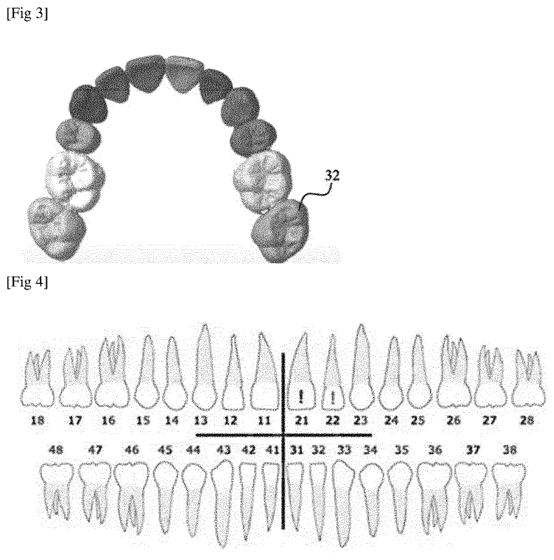

Further details and advantages of the invention are provided in the following detailed description, which is provided for non-limiting illustrative purposes.

### DETAILED DESCRIPTION

The purpose of the method according to the first and second aspects of the invention is to generate a plan for an orthodontic treatment that extends between an initial moment and a final moment. It can plan a complete orthodontic treatment or a partial orthodontic treatment, i.e. one that is insufficient to achieve the user's desired configuration on its own.

A partial orthodontic treatment corresponds to one phase in a complete orthodontic treatment, for example a distalization phase intended to move teeth apart so that they can then be repositioned, or a phase of aligning the barycenters of teeth along the curve of the arch that bears them, or a phase of rotating teeth about their barycenters.

In one embodiment, the method is implemented multiple times, for each phase in a complex orthodontic treatment.

In step A′), the computer determines the initial model for the first phase, or “first start-of-phase model”. This model represents the dental arch before the start of the complex orthodontic treatment. The computer divides it into tooth models, as in step a).

The computer, preferably a computer-aided dental practitioner, also determines the final model for the last phase, or “last end-of-phase model”, as in step a). This model represents the dental arch as desired at the end of the complex orthodontic treatment.

In step B′), the computer or a computer-assisted dental practitioner determines the end-of-phase models for each phase up to the penultimate phase by moving the tooth models, the end-of-phase model of the last phase having been determined in step A′).

The end-of-phase model of a phase represents a goal to be reached at the end of said phase. The start-of-phase model of a phase is the end-of-phase model of the phase that precedes it in time.

In one preferred embodiment, the computer defines the end-of-phase models, except possibly the last one, from the first start-of-phase model and the last end-of-phase model. To this end, the orthodontic rules needed to define the phases are taught in advance.

For example, in the previous example, after determining which tooth models need to be moved, by comparing the first start-of-phase model and the last end-of-phase model, the computer can move the tooth models of the first start-of-phase model until they are sufficiently far apart so that their barycenters can then be aligned along the curve of the arch, and then rotated on themselves so that the extrados of the tooth models are substantially aligned. The resulting model can be considered the first end-of-phase model.

Based on this model, the computer can then move the tooth models to align them with the curve of the arch. The resulting model can be considered the second end-of-phase model.

Based on this model, the computer can then rotate the tooth models to align their extrados faces. The resulting model can be considered the third end-of-phase model.

To find the end-of-phase models, the computer can use optimization algorithms, in particular simulated annealing.

In step C′), the computer implements a method according to the first and/or second aspect(s) of the invention for each phase. For each occurrence of this method, the initial model used is the model at the start of said phase and the final model used is the model at the end of said phase.

One example of a method according to the first embodiment is now described in detail. In this example, it is assumed that the orthodontic treatment to be planned comprises just one phase.

In step a), the initial and final models are generated.

### Initial Model

The initial model is a three-dimensional digital model representing the teeth to be moved, in their arrangement on the dental arch as planned at the start of the orthodontic treatment, i.e. at the initial moment.

The initial model is preferably prepared from measurements taken from the user's own teeth or from a physical model of the user's teeth, such as a plaster model.

The initial model is then preferably made less than a month before the initial moment, preferably less than two weeks, more preferably less than a week before the initial moment, so that it corresponds well to the arrangement of the teeth at the start of the orthodontic treatment.

The initial model is preferably created using a professional device, such as a 3D scanner, preferably implemented by a dental practitioner, e.g. an orthodontist or orthodontic laboratory. In an orthodontic practice, the user or the physical model of their teeth can advantageously be placed in a precise position, and the professional device can be enhanced. The result is a highly accurate initial model. The initial model preferably provides tooth positioning information with an error of less than 5/10 mm, preferably less than 3/10 mm, preferably less than 1/10 mm.

In one embodiment, the arrangement of the teeth may have changed between the moment of generation of the initial model and the initial moment. The initial model may, for example, have been generated more than a month or more than two months before the initial moment. The initial model is then updated, preferably deformed, preferably by moving one or more tooth models, to match the tooth arrangement at the initial moment. In particular, the initial model can be deformed to match one or more photos of the dental arch taken less than a week before the initial moment.

The number of points in the initial model is preferably greater than 5,000, 10,000 or 15,000 and/or fewer than 100,000. It then accurately represents the teeth. However, computer manipulation of an initial model may be slowed down if the number of points is high.

In one embodiment, the initial model comprises fewer than 5,000 points, or even fewer than 1,000 points, which speeds up implementation of the method. In particular, the time required to generate a deformation scenario, in particular using the first optimization algorithm described below, depends on the number of points in the initial model that are used to determine the first distance.

An initial model comprising fewer than 5,000 points, or “coarse model”, can in particular be the result of a simplification of a fine initial model, preferably acquired using a 3D scanner, for example with more than 10,000 or 20,000 points. The number of points in the initial model is preferably greater than 1,000 and/or fewer than 500,000.

In one embodiment, the simplification of an initial model results from a random selection of points on the surface of the initial model. In one embodiment, the initial model comprises all of the points that correspond to a point in the final model. Preferably, the initial model comprises only points that correspond to a respective point in the final model. In one embodiment, the initial model comprises no points of which the position cannot be affected by the orthodontic treatment.

In one embodiment, the initial model comprises only a set of points that is strictly sufficient to define the position and orientation in space of each tooth model. For example, it comprises, for each tooth model, only three non-aligned noteworthy points. Preferably, said set of points also comprises those points which may collide with adjacent tooth models, for example points in a tooth model which, in the initial model, are close to an adjacent tooth model.

A match can be established between the tooth models in the fine model and in the coarse model, which means that if a deformation scenario has been generated with a coarse initial model and thus comprises coarse transition models, high-precision fine transition models can be reconstructed which can be used, for example, to manufacture an orthodontic splint.

To deform an initial model, it is divided so as to generate a three-dimensional digital model for each tooth, or “tooth model”. The tooth models are then moved.

Preferably, the initial model is also divided so as to generate a three-dimensional digital model for the gum, or “initial gum model”.

### Final Model

The final model is a three-dimensional digital model representing the user's teeth in their arrangement on the dental arch as desired at the end of the orthodontic treatment, i.e. at the final, future moment. It is therefore a theoretical model.

The aim of the final model is to provide the information needed to define the orientation and position of each tooth in the arch at the final moment. The final model may be less accurate than the initial one. Specifically, the position of a tooth model can be defined by the position of a noteworthy point on this tooth model, for example by the position of its barycenter. The orientation of a tooth model can be defined by two non-parallel vectors, the common origin of which is, for example, the barycenter of the tooth model. Three noteworthy points, for example the barycenter and two points that are not aligned with the barycenter of a tooth model, can therefore be sufficient to define the configuration of a tooth. In this way, the final model can thus be made up of a set comprising, for each tooth model, coordinates of three noteworthy points on this tooth model.

Determining the position of a tooth is, for example, described in the article “Dense Representative Tooth Landmark/axis Detection Network on 3D”, par Guangshun Wei, Zhiming Cui, Jie Zhu, Lei Yang, Yuanfeng Zhou, Pradeep Singh, Min Gu, Wenping Wang, https://arxiv.org/pdf/2111.04212v2.pdf.

The final model may result from deforming the initial model by moving tooth models.

It can be determined conventionally by a dental practitioner, by moving tooth models, for example using the Treat program, described on the page https://en.wikipedia.org/wiki/Clear_aligners#cite_note-invisalignsystem-10.

In one preferred embodiment, in step a), the computer analyzes the initial model and deduces a final model therefrom. No tooth model manipulation is then required to define the final model. In one embodiment, however, the dental practitioner dictates constraints, for example according to the envisaged orthodontic treatment.

In one embodiment, a computer memory contains a “historical” database comprising a set of records, each record associating a historical initial model and a historical final model. In particular, the historical initial and final models may be models representing tooth arrangements of historical users at the start and end of “historical” orthodontic treatments.

The analysis of the initial model by the computer can then consist in
searching the database for the closest historical initial model, i.e. the one closest in shape to the initial model for which a final model is sought, then
selecting, for said final model, the historical final model associated with the closest historical initial model.

The user's dental arch is thus matched to the closest historical initial model, and the associated historical final model is assumed to be equally usable for the user.

A historical database can also be used to train one or more neural networks so that they provide the position and/or orientation of the tooth models in the final model. For example, it is possible to provide
as input, records each containing a tooth number and data defining a configuration of a tooth bearing said number for a historical user, and
as output, records each containing a tooth number and data defining an ideal configuration of a tooth bearing said number.

In particular, it is possible to use a network specialized in classifying images among those mentioned above.

In one embodiment, the computer uses predefined rules to transform the initial model into a final model. The predefined rules can, for example, specify that teeth in the final model must be aligned, specify a distance between the tips of adjacent tooth models, or specify an orientation for each tooth.

In one embodiment, the initial model is analyzed to
determine a curved base line following the curvature of the arch, e.g. connecting the barycenters of the teeth, and the length of the arch, e.g. the length of the base line;
determine the theoretical position and orientation of each tooth on said base line, according to predefined rules.

The algorithms for determining a base line and the tooth configuration are well known, particularly for panoramic tomography. In particular, a “mean square” value can be used, with a function of the type ax⁴+bx²+c=0.

The predefined rules can, for example, specify, according to the length and curvature of the arch, how the different teeth are to be distributed and oriented along said base line.

The predefined rules can be obtained, for example, via statistical processing of historical data providing, according to the length and curvature, said distribution and orientation of “historical” teeth in historical arches of historical users.

Advantageously, the computer can determine the final model very quickly, without human intervention.

The algorithms for comparing the shapes of two models are well known. The ICP or “Iterative closest point” algorithm, for example, is described in particular in the online encyclopedia Wikipedia.

In one preferred embodiment, the initial arch model is divided so as to generate an initial gum model, and the arrangement of the tooth models in the final model is checked for compatibility with the initial gum model. This check can be carried out by a dental practitioner and/or by a computer, either autonomously or controlled by an operator, such as a dental practitioner. Preferably, it is checked whether the tooth models in the final model penetrate into the initial gum model and/or whether a physiologically unrealistic gap has appeared between the tooth models in the final model and the initial gum model. In the event of such a penetration or gap, the initial gum model is transformed into a final gum model so as to eliminate said penetration or gap.

In step b), the computer determines a series of consecutive deformations of the initial model, leading to a final model.

The models resulting from consecutive elementary deformations before reaching the final model are called “transition models”. Each transition model therefore represents the arrangement of the teeth at a respective transition moment.

The number of transition models is preferably greater than three, preferably greater than 10 and/or fewer than 1000. It is preferably determined in such a way that no point in the model of the arch moves by more than 1000 μm, 500 μm or 100 μm between two consecutive transition models and/or in such a way that at least one point in the model of the arch moves by more than 10 μm, 50 μm or 100 μm between two consecutive transition models. This improves the accuracy of the deformation scenario.

Each elementary deformation must observe a set of constraints. The constraints comprise:
anatomical constraints, for example to dictate that, during the elementary deformation, a tooth model cannot penetrate into an adjacent tooth model, and/or that the positions of one or more points of a tooth model have to be contained within a defined envelope around the tooth model, and/or that the translational speed of a tooth model in one direction has to be lower than a defined upper limit for a translational speed, and/or that the rotational speed of a tooth model about one axis and in one direction has to be lower than a defined upper limit for a rotational speed;
preferably, clinical constraints dictated by the rules of orthodontics and/or the dental practitioner, e.g. dictating, during the elementary deformation, immobility of one or more tooth models, e.g. due to a problem with the gum, bone density or the presence of one or more dental implants, and/or dictating technical constraints to be observed for moving a tooth model, e.g. due to available orthodontic appliances, and/or favoring some movements over others, and/or dictating an order for moving the tooth models, and/or dictating a correct occlusion, and/or allowing or prohibiting stripping of teeth, and/or allowing limited stripping of teeth, and/or allowing or prohibiting extraction of one or more teeth, and/or dictating movement of one or more teeth that is as uniform as possible, i.e. limiting variations in movement speeds of one or more teeth as much as possible, and/or dictating an upper limit for a movement speed of one or more teeth, and/or dictating the presence of one or more phases and/or an order for carrying out said phases;
preferably, instruction constraints dictated by the user due, for example, to a need for an orthodontic treatment that causes limited pain and/or has a limited duration and/or has a limited cost, and/or has a limited number of steps and/or has a predetermined number of steps, and/or allows or prohibits tooth stripping, and/or allows limited tooth stripping, and/or allows or prohibits extraction of one or more teeth, and/or allows or prohibits the use of one or more auxiliary orthodontic appliances.

The set of constraints dictated for an elementary deformation can be different depending on the arch model to which the elementary deformation applies, or “model to be deformed”, i.e. the initial model or a transition model. For example, the possible positions and orientations for a tooth model may be limited by the presence of adjacent tooth models, the positions and orientations of which may themselves change with each elementary deformation.

In one embodiment, the set of constraints comprises constraints that may lead to an elementary deformation which is not directly applicable in reality. In particular, the set of constraints may allow limited penetration of one tooth model into an adjacent tooth model. The resulting elementary deformation then dictates the stripping of one or both teeth of which the tooth models penetrate into one other in order to work. Preferably, the computer informs the dental practitioner of the need for such stripping.

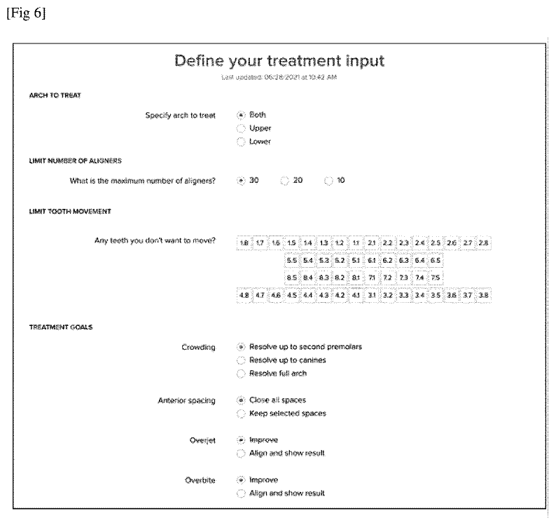

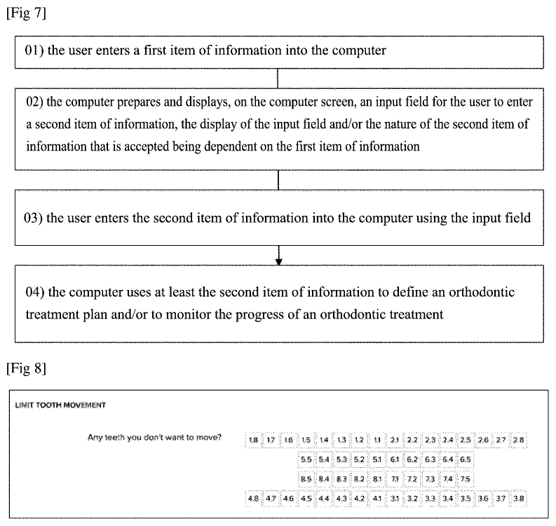

All or some of the constraints can be determined from information entered by the user, preferably using a dynamic form. FIG. 6 illustrates an exemplary page of such a form. FIG. 7 illustrates the use of a dynamic form according to the third main aspect of the invention.

In particular, the user can specify
a maximum number of orthodontic aligners for the orthodontic treatment, i.e. a maximum number of intermediate moments;
the numbers of teeth that must remain immobile during the orthodontic treatment, in particular by clicking on the boxes bearing the numbers of these teeth.

FIG. 8 shows, for example, a teeth map. The user can select one or more teeth by clicking on the representation of the number of said teeth on this map.

The page shown in FIG. 6 also allows the user to specify treatment objectives, which can be used by the computer to determine a model of the arch at the end of orthodontic treatment.

The elementary deformations, and therefore the deformation scenario, are preferably determined by means of a computer program called the “generator”, implemented by the computer.

Preferably, the initial model is divided by the computer. Dividing the initial model in order to determine the models of the organs that it represents is a well-known operation. Preferably, the initial model is divided in order to define at least the parts that represent the teeth, or “tooth models”. The tooth models can be defined as described, for example, in international application PCT/EP2015/074896.

To determine an elementary deformation, the generator moves tooth models while observing all of the constraints. The elementary deformations comprise, and are preferably exclusively, tooth model movements.

An elementary deformation is determined quickly, even if the tooth models are moved randomly, especially if the number of points in the initial model is low. However, a deformation scenario can take a long time to determine.

To speed up the search for a deformation scenario, the generator can implement rules used by dental practitioners to generate an orthodontic treatment plan. For example, it can
favor movements of tooth models along the shortest or fastest path to the final model, taking account of one or more tooth models, for example by defining said path as the sum of the paths traveled by a plurality of tooth models, preferably taking account of all of the tooth models, and
only deviate from this path in the event of a collision with an adjacent tooth model.

Preferably, the generator implements a first optimization algorithm, preferably a metaheuristic, preferably evolutionary, preferably simulated annealing method. In particular, the first optimization algorithm can be selected from among the algorithms listed above in the definition of metaheuristic methods.

The first optimization algorithm can implement the following steps:
i) creating a “to-be-tested” scenario, i.e. applying, to the initial model, a set of consecutive “to-be-tested” elementary deformations, preferably exclusively by moving tooth models, so as to obtain a “to-be-tested” arch model;
ii) determining a first distance measuring a difference in shape between the to-be-tested model and the final model:
iii) comparing said first distance with a first threshold to obtain a first score for the to-be-tested scenario;
iv) if the first score is insufficient, e.g. higher than a predetermined minimum first score, modifying the to-be-tested scenario and returning to step i).

The cycle of steps i) to iv) is thus repeated until the score of the to-be-tested scenario is satisfactory, i.e. the to-be-tested model can be considered sufficiently close to the final model. The to-be-tested scenario can then be considered as a “deformation scenario”.

In step i), the to-be-tested scenario can be randomly generated.

It is preferably created by taking account of the scores obtained in previous cycles, for example to avoid applying elementary deformations that do not produce good scores. Preferably, the creation of a to-be-tested scenario is guided by rules used by dental practitioners to generate an orthodontic treatment plan. For example, the to-be-tested scenario may be chosen to favor movements of tooth models along the shortest path to the final model, deviating from this path only in the event of a collision with an adjacent tooth model.

In step i), the to-be-tested scenario can be, in particular, the to-be-tested scenario from the preceding cycle, to which an additional elementary deformation is added. In other words, the to-be-tested model results from an additional elementary deformation applied to the to-be-tested model from the preceding cycle. The to-be-tested scenario is thus “extended” from one cycle to the next, until an acceptable scenario is reached. In one embodiment, constructing the deformation scenario in this way is stopped if said first distance becomes greater, with a predetermined deviation, possibly zero, than that of a previously determined to-be-tested scenario.

In step ii), said first distance is, for example, the sum of the Euclidean distances between points in the to-be-tested model and the corresponding points in the final model.

In step iii), the first score can be, for example, the inverse of the difference between said first distance and the first threshold. The first threshold can be zero, so that the cycle of steps i) to iv) leads to the final model.

Preferably, the generator generates a plurality of arch deformation scenarios and then selects the one that minimizes a distance from an ideal deformation scenario, for example causing minimal total deformation. Such a deformation scenario is called the “optimal deformation scenario”.

Even more preferably, the generator implements a second optimization algorithm in order to search for an optimal deformation scenario. The second optimization algorithm is preferably a metaheuristic, preferably evolutionary, preferably simulated annealing method. In particular, the second optimization algorithm can be selected from among the algorithms listed above in the definition of metaheuristic methods.

The second optimization algorithm can implement the following steps:
i′) creating a “to-be-tested” deformation scenario, preferably using the first optimization algorithm;
ii′) measuring a second distance measuring a difference between the to-be-tested deformation scenario and an ideal arch deformation scenario;
iii′) comparing said second distance with a second threshold to obtain a second score for the to-be-tested deformation scenario, the second score being, for example, the inverse of the difference between said second distance and the second threshold; iv′) if the second score is insufficient, for example greater than a predetermined minimum second score, modifying the to-be-tested deformation scenario and returning to step i′).

The cycle of steps i′) to iv′) is thus repeated until the score of the to-be-tested deformation scenario is satisfactory, i.e. the to-be-tested deformation scenario can be considered sufficiently close to the ideal deformation scenario. The to-be-tested deformation scenario is then an “optimal” deformation scenario.

The second distance can be, for example, the cumulative Euclidean distance traveled by a set of points in the initial model, for example all of the points in the initial model, during the to-be-tested deformation scenario. This Euclidean distance is preferably minimal in an ideal deformation scenario, such that the second threshold can be, for example, zero and the second score equal to the second distance. The set of points preferably comprises one, preferably more than one, more than two points for at least one tooth model in the initial model, preferably at least two, preferably at least three tooth models in the initial model, preferably for each tooth model in the initial model. The second distance can give higher weights than the Euclidean distances traveled by certain points, for example points belonging to tooth models representing teeth for which movement has to be particularly limited.

If the second threshold is zero, the second distance can define the second score. Step iii′) is then unnecessary. It is therefore optional.

Preferably, the second distance takes into account one or more instructions dictated by the user. For example, the user may have filled in a computer questionnaire to specify these instructions, for example to specify the relative importance that they gives to the speed of the orthodontic treatment, and/or to the pain caused by the orthodontic treatment, for example measured by a pain coefficient, and/or to comfort during the orthodontic treatment, for example measured by a comfort coefficient, and/or to the cost of the orthodontic treatment.

Comfort can refer in particular to the esthetic impact of the orthodontic treatment.

In one embodiment, the second distance therefore depends on the duration and/or on a pain coefficient and/or on a comfort coefficient and/or on a cost associated with the to-be-tested deformation scenario. The duration, pain coefficient and cost are preferably minimal in an ideal deformation scenario, such that the basis for comparison of these criteria may be zero, for example. The comfort coefficient is maximum in the ideal deformation scenario, such that the basis for comparison of this criterion can be, for example, the maximum possible value for this coefficient.

The assignment of a duration (or a duration coefficient normalizing the duration) and/or of a pain coefficient and/or of a comfort coefficient and/or of a cost (or of a cost coefficient normalizing the cost) to a to-be-tested deformation scenario can be determined by a dental practitioner or, preferably, by an evaluation module programmed into the computer implementing rules conventionally applied by dental practitioners or determined by the computer by means of statistical processing. The to-be-tested deformation scenario can, for example, be compared with historical arch deformation scenarios from a database in order to determine a similar historical deformation scenario, and inherit information on the duration, pain coefficient, comfort coefficient and/or cost therefrom.

The criteria (duration, pain coefficients, comfort coefficients, cost) for the historical arch deformation scenarios can be evaluated on the basis of surveys of people who have been treated according to said historical arch deformation scenarios and/or of dental practitioners who have performed these treatments.

A neural network can also be trained to assign a duration (or a duration coefficient) and/or a pain coefficient and/or a comfort coefficient and/or a cost (or cost coefficient) to a to-be-tested deformation scenario. In particular, it is possible to use a network specialized in classifying images among those mentioned above, which, rather than being trained to provide probabilities of occurrence of different predefined classes, is trained to provide a value in an infinite set of values, i.e. a continuous value. For training, a deformation scenario, or preferably only the initial and final models, and a duration (or duration coefficient), pain coefficient, comfort coefficient or cost (or cost coefficient) associated with this deformation scenario, can thus be provided as input.

For example, if
lᵢ denotes the distance traveled by a point Pi in a tooth model of the arch according to the to-be-tested deformation scenario,
k₁ denotes a weight for a duration coefficient, for example between 1 and 10, preferably provided by the user, depending on the importance that they give to the speed of the orthodontic treatment,
k₂ denotes a weight for a pain coefficient, for example between 1 and 10, preferably provided by the user, depending on the importance that they give to the pain that the orthodontic treatment may inflict,
k₃ denotes a weight for a comfort coefficient, for example between 1 and 10, preferably provided by the user, depending on the importance that they give to comfort during the orthodontic treatment, and
k₄ denotes a weight for a cost coefficient, for example between 1 and 10, preferably provided by the user, depending on the importance that they give to the cost that the orthodontic treatment will entail,
C denotes an instruction factor taking account of the duration_{C1}, and/or pain_{C2} and/or comfort_{C3}, and/or cost_{C4} coefficients associated with a to-be-tested deformation scenario, for example equal to a polynomial function of these coefficients, for example equal to (k₁*C₁+k₂*C₂+k₃*C₃+k₄*C₄), the second distance and/or the second score could be, for example:
the sum of lᵢ for a set of N points “i”, N preferably being greater than 10; or
the product of the sum of lᵢ for a set of N points “i” with the instruction coefficient.

In one embodiment, a deformation scenario, preferably an optimal deformation scenario, is first sought with a coarse initial model, for example containing 100 points. The initial, transition and final models are then completed in order to check that there are no unacceptable collisions, i.e. those that cannot be eliminated by stripping, in the case where stripping is permitted. In the event of an unacceptable collision, i.e. if the computer finds that the deformation scenario includes interpenetration of adjacent tooth models beyond an acceptable limit, points are added to the initial model, and said search is repeated with the simplified initial model from the preceding cycle to which the points have been added.

In one preferred embodiment, the initial arch model is divided so as to generate an initial gum model, and, consecutively for each transition model, the arrangement of the tooth models in the transition model is checked for compatibility:
with the initial gum model, for the first transition model, or
with the gum model in the preceding transition model, for subsequent transition models.

This check can be carried out by a dental practitioner and/or by a computer, either autonomously or controlled by an operator, such as a dental practitioner. Preferably, it is checked whether the tooth models in the transition model in question penetrate into the gum model and/or whether a physiologically unrealistic gap has appeared between the tooth models and the gum model. In the event of such a penetration or gap, the gum model is modified so as to eliminate said penetration or gap. Each transition model thus presents a representation of the gum that is compatible with the arrangement of the tooth models.

In step c), the computer determines the final moment for the scenario determined in step b).

To this end, the deformation scenario can be compared, for example, with historical arch deformation scenarios from a database which provides the associated treatment duration for each historical arch deformation scenario.

The duration of the scenario, and therefore the final moment, can then be determined from the duration of a similar historical deformation scenario, for example selected so as to be equal to the duration of the similar historical deformation scenario.

The steps of the orthodontic treatment in the deformation scenario resulting from step b) are marked by the intermediate moments at which a check of the arch by a dental practitioner and/or a modification of an orthodontic appliance worn by the user and/or manufacture of an orthodontic appliance for the user are to be carried out.

Modifying an orthodontic appliance worn by the user may involve modifying the structure or shape of the appliance, or replacing it with a new orthodontic appliance. In one embodiment, the intermediate moments are the moments at which orthodontic aligner replacements are scheduled.

The intermediate moments are preferably moments when a change of orthodontic aligner is planned.

The intermediate moments can be selected so that the time interval between two consecutive intermediate moments, preferably between any two consecutive intermediate moments, is within a predetermined range, preferably either constant and/or equal to the maximum duration of use of an orthodontic appliance, for example the duration of use of an orthodontic aligner.

The transition models at the intermediate moments are the “intermediate models”.

The number of intermediate models is preferably less than 0.1 times the number of transition models. It is preferably greater than or equal to 1 and/or smaller than 150.

In one embodiment, the number of intermediate models is equal to the number of transition models.

Preferably, the intermediate moments and the final moment are determined according to the movements of the tooth models according to the deformation scenario and the envisaged orthodontic appliances. Specifically, the possibilities for tooth movements according to the different possible translational and rotational movements differ depending on the number of the tooth in question and the envisaged orthodontic appliance. For example, due to the capabilities of the polymer used to manufacture orthodontic aligners, a translation for the intrusion or extrusion of a tooth between two steps can be limited to less than 0.1 mm, a rotation can be limited to less than 3° degrees of rotation, tip or torque, etc. By knowing the necessary movements between the initial and final models, these constraints linked to the properties of orthodontic aligners can be used to calculate intermediate and final moments that are compatible with the orthodontic aligners and orthodontic treatment.

The way in which the intermediate and final moments are determined is not limiting. The rules conventionally used by dental practitioners to select the most suitable intermediate moments can be applied by the computer.

In one preferred embodiment, the computer proceeds as follows:

The initial model is divided into tooth models, and the elementary deformations of the deformation scenario result from translational and/or rotational movement of the tooth models. Preferably, the number of each tooth represented in the initial model is identified during the division of the initial model by labeling performed by an operator or, preferably, by shape recognition performed by the computer, for example by means of a neural network. Such shape recognition performed by computer is well known to those skilled in the art.

The movement kinetic capabilities of a tooth differ according to the nature of this tooth. In particular, the highest physiologically acceptable values for translational or rotational movement speeds for a tooth in different spatial directions depend on the number of the tooth. These movement capabilities make it possible to define the constraints of each set of constraints dictated for each elementary deformation. In particular, these constraints can set, for each tooth model, upper limits for translational and rotational movement speeds on the various axes of a reference frame, for example an orthonormal reference frame, fixed relative to the user's skull.

The upper limit of a movement speed can be, in particular, the highest physiologically acceptable value for this speed.

Tooth movement kinetic capabilities can be determined via statistical analysis, in particular by analyzing panoramic and/or cephalometric X-rays of historical users. They can also be determined by analyzing panoramic X-rays and/or cephalometric X-rays of the user implementing the method. In one embodiment, tooth movement kinetic capabilities are determined via statistical analysis of historical data, i.e. data relating to historical users, and the values obtained are then refined according to the user for whom the method is implemented, for example to take account of their bone density per tooth and/or the condition of their gums.

Based on a computerized table giving the upper limits for translational and rotational movement speeds for each tooth number, along the different axes of the reference frame, the computer can therefore determine said upper limits for each tooth model.

Furthermore, for a deformation scenario, the “path” of a tooth model comprises all of the configurations of the tooth model from the initial model to the final model, i.e. in the initial, transition and final models. This makes it possible to determine the distance traveled in space by each point in a tooth model as the deformation scenario unfolds. It is also possible to determine the angular sector traveled, about each of the three axes of the reference frame, by each tooth model as the deformation scenario unfolds.

For each tooth model, assuming that it moves at the highest possible speeds within the constraints, i.e. as far as possible at the upper limits of these speeds defined by the constraints, it is thus possible to determine the shortest possible time for this tooth model to change its configuration from the initial model to the final model, depending on the deformation scenario.

The tooth model that imposes the longest duration is called the “limiting tooth model” because the deformation scenario cannot be carried out any faster. This duration, which is the duration of the orthodontic treatment plan, can be added to the initial moment to determine the final moment, and it is possible to date each moment in the deformation scenario.

The limiting tooth model can be defined by analyzing the paths of the different tooth models, according to the deformation scenario, preferably by computer. Alternatively, the limiting tooth model can be predefined, for example because it is conventionally identified as limiting for the orthodontic treatment.

The deformation scenario is then broken down so that the limiting tooth model can follow its path, the intermediate moments defining the breakdown being determined according to the capabilities of the one or more orthodontic appliances to implement the deformation scenario. For example, it is possible to define the moments at which the orthodontic appliance worn by the user should be adapted so that the limiting tooth model can follow its path.

In particular, in the context of an orthodontic treatment using orthodontic aligners, an orthodontic aligner allows only limited movement of a tooth. For example, its limited elasticity may mean that any point on any tooth will always move less than a limit of around 1 mm, or even always less than 0.5 mm. In other words, when a point on a tooth has moved by 1 mm since the orthodontic aligner was fitted, the orthodontic aligner has to be changed. Knowing the amount of tooth movement possible with an orthodontic aligner thus makes it possible to determine the intermediate moment at which the aligner should be changed.

For example, for an orthodontic treatment in which a molar has to move by 3 mm and a canine has to move by 4 mm, the upper limit for the speed of movement of the molar being 1 mm per month and that of the canine being 2 mm per month, it takes at least three months to move the molar and two months to move the canine. The model of the molar is therefore the limiting tooth model, and the duration of the orthodontic treatment is four months. The intermediate moments can be selected so as to mark a movement of 1 mm each time from the preceding (intermediate or initial) moment, if the orthodontic aligners are adapted to ensure a movement of 1 mm each. The intermediate moments are therefore, if to is the initial moment, to +1 month, to +2 months, and to +3 months.

The orthodontic treatment plan thus defined may, however, dictate a path for a model of a molar that is very fast, leading to pain for the user and/or increased risk to the user's health. The following step d), and the second main aspect of the invention, addresses this problem.

In step d), which is optional, in one particularly advantageous embodiment, the generator, preferably the first and second optimization algorithms, is/are used to search for a new, preferably optimal, deformation scenario, referred to as “smoothed” but with, for each elementary deformation, a new set of constraints dictating
for the limiting tooth model, compliance with the path determined according to the deformation scenario determined in step b), and
for at least one other tooth model than the limiting tooth model, called the “slowed tooth model”, a reduction, preferably an optimization, of a said speed parameter.

Preferably, the new set of constraints dictates upper limits for movement speeds that are lower than those obtained according to the orthodontic treatment plan resulting from step c). In other words, the set of constraints dictates that the speeds of said slowed tooth model, modeling a “slowed tooth”, cannot reach the maximum values that the nature of said other tooth would allow. For example, for one or more of the movement speeds of the slowed tooth, it dictates an upper limit lower than the upper limit dictated to establish the orthodontic treatment plan resulting from step c).

Smoothing advantageously makes it possible to improve the predictability of the treatment, i.e. to increase conformity between the orthodontic treatment plan and its subsequent implementation in the user's mouth.

Preferably, the amplitude of the variation in speed during the movement of the slowed tooth is limited over the duration of the treatment, i.e. the difference between the highest and lowest speeds reached over the duration of the treatment is reduced. To this end, the computer can also dictate one or more minimum values for one or more speeds of the slowed tooth model, i.e. lower limits for said speeds.

Again preferably, the computer calculates at least one average speed for the slowed tooth model according to the deformation scenario obtained in step c), for example an average speed of a point in translation or rotation about an axis, averaged over the duration of the orthodontic treatment plan resulting from step c). The set of constraints then dictates that the instantaneous speed of said slowed tooth model cannot vary by more than a certain percentage of said average speed, for example by more than +/−20% or +/−10%. Advantageously, the movement of said slowed tooth model is thus more regular.

The deformation scenario thus smoothed advantageously limits risks to the user.

Smoothing can be carried out for a plurality of teeth simultaneously when the new set of constraints dictates that the speeds of a plurality of slowed tooth models cannot reach the maximum values that the nature of the teeth that they model would allow.

In one preferred embodiment, smoothing is carried out consecutively for a plurality of slowed tooth models.

On each iteration of step d), the computer adds compliance with a new path for a tooth model, the path of which was not dictated in previous steps d), to the constraints. Smoothing is preferably carried out tooth by tooth, preferably starting with those teeth for which fast movement is most likely to be detrimental to the user. In other words, the first smoothing operations preferably concern those teeth for which fast movement is most detrimental to the user.

In the above example, the generator can thus seek a smoothed, preferably optimal, deformation scenario as described above, by dictating that the tooth model modeling the molar observes the path determined according to the deformation scenario determined in step b) and that the instantaneous speed of the tooth model modeling the canine does not exceed the upper limit defined for a canine by more than 10%, at any moment. It then further searches for a new, preferably optimal, smoothed deformation scenario as described above, dictating that said tooth models modeling said canine and said molar observe their respective paths determined according to the previous smoothed deformation scenarios and that the instantaneous speed of a tooth model modeling, for example, an incisor does not exceed, for example, the upper limit defined for an incisor by more than 10%, at any moment.

Smoothing can be repeated for each tooth. If smoothing is unsuccessful, the speed constraint, for example limiting the variation in speed to less than 10% of the average speed, can be relaxed. It is also possible to repeat previous smoothing operations while relaxing the speed constraints for these previous smoothing operations.

In one embodiment, the computer implements an optimization algorithm in order to test multiple sets of constraints to be dictated for the elementary deformations, and deduce therefrom an optimally smoothed deformation scenario, i.e. one in which the largest values reached for the speeds of the slowed tooth model are the lowest possible. The amplitude of the range of possible speeds is advantageously reduced as much as possible.

The computer can also or alternatively present the different smoothed deformation scenarios to a dental practitioner so that they can selected the smoothed deformation scenario that they prefer. The dental practitioner's selection criteria can also be programmed into the computer so that the computer can select a deformation scenario.

In step e), subsequent to step c), and potentially step d), the intermediate models are used to design and manufacture one or more orthodontic appliances, such as one or more orthodontic aligners. They can be designed by computer, potentially together with a dental practitioner. They can be manufactured by any suitable manufacturing machine.

As is now clear, the invention allows a partial or complete orthodontic treatment plan to be implemented very quickly. Tests have shown that a deformation scenario can be determined by the computer in less than 10 minutes, then broken down by the computer to obtain a good-quality treatment plan that complies with the user's instructions. Smoothing the speeds also makes it possible to limit risks to the user's health.

### Smoothing Method

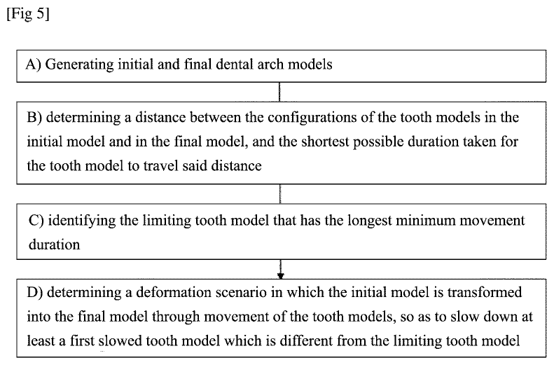

The smoothing method described above can advantageously be generalized to a method comprising steps A) to D), illustrated in FIG. 5.

In step A), to generate or retrieve the initial and final models, a step a) is preferably followed.

In step B), the measured distance for a tooth model can be defined in any way.

For example, after overlaying the initial and final models so that the immobile parts of the arch merge, it is possible to measure
the Euclidean distance between a point in the initial model, in particular a noteworthy point such as the barycenter, and the corresponding point in the final model;
the cumulative Euclidean distance between multiple, preferably noteworthy, points in the initial model and the corresponding points in the final model.

A distance resulting from simple measurements measuring the difference in tooth model configurations between the initial model and the final model, for example the sum of the Euclidean distances between points of the tooth model in the initial model and the corresponding points of the tooth model in the final model, advantageously limits the calculations for finding the limiting tooth. In one embodiment, no deformation scenario is determined before the first smoothed deformation scenario.

After overlaying the initial and final models in such a way that the immobile parts of the arch merge, the distance traveled by one or more, preferably noteworthy, points can for example be measured according to a basic deformation scenario between the model and the final model, preferably as defined according to the first main aspect of the invention.

The distance traveled for a set of points in the tooth model according to a basic deformation scenario, as for step d), is more complex since it requires defining said basic deformation scenario, preferably according to a step b). However, it is more precise and advantageously makes it possible to limit the risk of error when determining the limiting tooth.

Distance measurement is preferably carried out autonomously by computer.

The duration taken for a tooth model to travel the distance can be roughly estimated, for example by dividing the distance measured for a tooth model by a constant speed set for said tooth model. The speed assigned to a tooth model is preferably determined according to the number of the modeled tooth and/or according to the physiological possibilities for the movement of the modeled tooth.

In one advantageous embodiment, the speed assigned to a tooth model is variable depending on the moment in question. In particular, it may increase from the initial moment, for example for more than five days from the initial moment, and/or it may decrease as an estimate of the final moment approaches, for example at least over the five days preceding the estimate of the final moment. Preferably, it is lower for moments close to the initial moment and the estimate of the final moment.

Said constant speed may be a speed representative of one or more movement speeds of one or more points in the tooth model. It may be, for example, the modulus of the translational velocity vector of the barycenter of the tooth model.

The duration taken for a tooth model to travel the distance can be estimated more finely. For example, the speed of a tooth model may be variable, and in particular depend on the nature of the movement in question, and therefore depend on the movement in question over a path of the tooth model between its configurations in the initial and final models. The path of a tooth model can be determined by establishing a basic deformation scenario according to a step b).

The elementary duration between two consecutive configurations of the tooth model can be determined, for example, by dividing the elementary distance traveled by this tooth model between these two configurations by a speed determined for this elementary distance. The distance travel duration measuring the difference between the configurations of the tooth model in the initial model (initial configuration) and in the final model (final configuration) can then be the sum of the elementary durations determined between the different consecutive configurations from the initial configuration to the final configuration.

The distance travel duration is preferably determined by a computer, autonomously, i.e. without human intervention, preferably by the computer that implemented the preceding step.

In step C), the durations determined for each tooth model are compared, and then the limiting tooth model associated with the longest duration is retained. The movement of the limiting tooth that it models sets the shortest possible duration for the orthodontic treatment.

The duration associated with the limiting tooth model defines the duration of the orthodontic treatment. It can be added to the initial moment to define the final moment.

The comparison of the durations is preferably carried out autonomously by a computer, preferably by the computer that implemented the preceding steps.

In one preferred embodiment, for each tooth model and for each type of movement (intrusion/extrusion, mesialization/distalization, lingualization/vestibularization, tip, torque and rotation), a distance to be traveled between the initial configuration and the final configuration is calculated, and this distance is divided by the maximum speed. The longest duration determines the limiting tooth model.

In step D), the computer determines the first smoothed deformation scenario, preferably so as to reduce, preferably minimize said velocity parameter.

Preferably, the computer determines the first smoothed deformation scenario so as to reduce, preferably minimize, between the initial moment and the final moment, the greatest value of at least one movement speed reached for at least one tooth model other than the limiting tooth model, or “first slowed tooth model”.

The first slow tooth model models a “first slow tooth”. The first slowed tooth is preferably, from among all of the teeth modeled in the initial model and with the exception of the limiting tooth modeled by the limiting tooth model, the tooth of the arch of which the movement speed is the most critical for the user's health, i.e. the tooth of which a rapid movement entails the highest risk for the user. In one embodiment, the computer determines the first smoothed deformation scenario so as to slow down all of tooth models other than the limiting tooth model.

Regardless of the embodiment, step D) is preferably repeated while each time changing the tooth model that is slowed down by dictating, on each occurrence of step D), that the tooth models that have been slowed down in prior steps D) follow the path defined in these prior steps D), as described for step d).

The order in which the tooth models are consecutively slowed down is preferably determined according to utility criteria defined by the dental practitioner and/or user.

After step D), the method can comprise a step e) of designing and manufacturing at least one orthodontic appliance, in particular an orthodontic aligner, based on the first smoothed orthodontic treatment plan.

### Example

In step A), the computer retrieves an initial model resulting from a scan of the user's arch by means of an optical scanner.

The dental practitioner, assisted by the computer, or the computer alone, determines a final model.

In steps B) and C), the dental practitioner assisted by the computer, or the computer alone, searches for a basic deformation scenario between the initial and final models as described in step b), i.e. paths for each of the tooth models. It then determines the limiting tooth model and the final moment based on the paths (to determine the distance traveled) and kinetic capacities (to determine the distance travel duration) of the tooth models.

Alternatively, the dental practitioner assisted by the computer, or the computer alone, does not determine a basic deformation scenario, but determines the limiting tooth model by comparing distances between the initial and final configurations of different tooth models.

Once the limiting tooth model has been identified, the method preferably attempts to move the other tooth models as slowly as possible.

In step D), the dental practitioner assisted by the computer, or the computer alone, selects the “slowed tooth model”, preferably the tooth model for which slowing down is the most beneficial for the user's health and/or for meeting the user's instructions.

To determine the first smoothed deformation scenario, the computer searches for a set of consecutive elementary deformations that transform, through the movement of tooth models, the initial model at the initial moment into the final model at the final moment, and minimize the speed parameter for the slowed tooth model. It preferably implements a conventional optimization algorithm, preferably a metaheuristic method, preferably selected from among the methods described above.

In particular, the cost function to be minimized can be the highest movement speed reached by the slowed tooth model between the initial moment and the final moment. This speed can be determined as the highest instantaneous speed between these moments, the instantaneous speed being calculated by dividing a distance between two consecutive configurations of a tooth model by the time interval between these two configurations.

In a substantially equivalent way, optimization can also be achieved by defining the sets of constraints dictated for the elementary deformations in such a way that they all dictate that the instantaneous speed (for said movement speed) between two consecutive elementary deformations is lower than a given value. The computer then searches for a deformation scenario that observes these sets of constraints and, if successful, reduces the determined value. In an iterative manner, the computer can then determine the lowest possible value for the upper limit of the movement speed between the initial moment and the final moment, thereby allowing a deformation scenario to be defined. This deformation scenario is then a first smoothed deformation scenario.

Preferably, steps D) are then repeated, consecutively for other slowed tooth models, with priority given to those tooth models for which slowing down is the most beneficial for the user's health and/or for meeting the user's instructions.

Intermediate moments can be defined, preferably at the end of the method, according to the action capabilities of the one or more orthodontic appliances envisaged for the orthodontic treatment.

In one preferred embodiment, when determining a smoothed deformation scenario, configurations are dictated at certain moments for tooth models.

In particular, to determine the first smoothed deformation scenario, the sets of constraints dictate configurations for the limiting tooth model. Dictated configurations are preferably “transition” configurations in transition models of a basic deformation scenario, preferably configurations at intermediate moments.

Similarly, to determine the second smoothed deformation scenario on the second occurrence of step D), the sets of constraints dictate configurations for the limiting tooth model and for the first slowed tooth model. Dictated configurations are preferably “transition” configurations in transition models of the first smoothed deformation scenario, preferably configurations at intermediate moments. A similar procedure is followed for subsequent occurrences of step D).

Preferably, steps B) to D) are carried out autonomously by a computer.

In one embodiment, smoothing is carried out in order to enhance an existing orthodontic treatment plan.

A dental technician or practitioner defines an orthodontic treatment plan using a computer, preferably conventionally, for example using the Treat software, starting from the initial model, moving tooth models from the initial model to a configuration as desired at the end of the orthodontic treatment. In this way, intermediate moments are determined, in particular for orthodontic aligner changes, the final moment and a “conventional” deformation scenario comprising the intermediate models of the dental arch at the intermediate moments.

Based on these data, which are preferably determined conventionally, the computer can carry out steps B) to D), preferably autonomously. This provides the dental practitioner or technician with a solution that allows them to refine the orthodontic treatment plan that they have drawn up.

As is now clear, the method according to the invention allows the computer to spread the path of tooth models as much as possible across the time interval between the initial moment and the final moment, i.e. to smooth out the movement of tooth models as much as possible by reducing the instantaneous movement speeds of tooth models as much as possible.

Of course, the invention is not limited to the embodiments described in detail above.

1. A method for generating a plan for the orthodontic treatment plan of a user's dental arch, the method comprising the following consecutive steps:
a) generating or retrieving an “initial” model representing said dental arch in three dimensions at an initial moment, said initial model being broken down into tooth models, and generating or retrieving a “final” model representing said dental arch with a “final” arrangement of tooth models desired at the end of the orthodontic treatment;
b) determining, using a computer, a set of successive elementary deformations transforming the initial model into the final model by moving the tooth models, said elementary deformations each adhering to a respective set of constraints, the models resulting from the successive elementary deformations being called “transition models”, the succession of the set of successive transition models being called a “basic deformation scenario”;
c) determining, using the computer,
a duration for deforming the dental arch according to the deformation scenario, from the initial moment until the final arrangement is obtained at a final moment; and
intermediate moments between the initial and final moments for performing the deformation of the dental arch according to the basic deformation scenario, the intermediate moments being moments at which an inspection of the arch by a dental practitioner and/or a modification of an orthodontic appliance and/or a fabrication of an orthodontic appliance is/are planned,
the basic deformation scenario and said intermediate moments defining said orthodontic treatment plan, known as the “basic orthodontic treatment plan”.

2. The method according to claim 1, wherein, in step a), said computer determines the final model from the initial model.

3. The method according to claim 2, wherein, in step a), to determine the final model, said computer
analyzes the shape of the initial model so as to determine the curvature and length of the dental arch, and defines a baseline having said curvature and length, and then,
for each of a plurality of tooth models, determines a position and orientation of said tooth model relative to said baseline from predefined rules and/or by treating the user's dental arch as akin to a historical dental arch similar to said user's dental arch.

4. The method according to claim 2, wherein, prior to step a), the predefined rules are determined by statistical processing of historical data.

5. The method according to claim 1, wherein, at the start of step c), the computer
determines, for each tooth model, the moment closest to the initial moment at which the tooth model can, by following the basic deformation scenario determined in step b), reach its configuration in the final model, or “end-of-path moment”;
determines, from the set of tooth models, a tooth model with the end-of-path moment furthest from the initial moment, or “limiting tooth model”;
sets the final moment as the end-of-path moment of the limiting tooth model.

6. The method according to claim 5, wherein the computer determines the end-of-path moment of a tooth model by dividing a distance representative of the tooth model's movement during the basic deformation scenario by a speed representative of the kinetic capabilities of said tooth model.

7. The method according to claim 5, comprising, after step c), the following first step d):
d) determining, by the computer, a new deformation scenario known as the “first smoothed deformation scenario”, wherein
the limiting tooth model follows the path defined by the basic deformation scenario determined in step b), and
wherein at least one speed parameter is optimized,
the first smoothed deformation scenario and said intermediate moments defining a new orthodontic treatment plan, referred to as the “first smoothed orthodontic treatment plan”.

8. The method according to claim 7, wherein the speed parameter is selected from:
the greatest value of a movement speed of said slowed-down tooth model achieved between the initial moment and the final moment, and/or
the difference between said highest value of said movement speed and the lowest value of said movement speed of said slowed-down tooth model between the initial moment and the final moment, and/or
the variation in said movement speed of said slowed-down tooth model, on average, between the initial and final moment.

9. The method according to claim 7, comprising, after said first step d), one or more successive additional steps d), each additional step d) comprising the determination, by the computer, of an additional smoothed deformation scenario wherein
the limiting tooth model follows the path defined by the basic deformation scenario determined in step b), and
the slowed-down tooth model(s) of step(s) d) prior to said additional step d) follow(s) the path(s) defined by said smoothed deformation scenario(s) determined in said prior step d) or in said prior steps d), respectively,
the additional smoothed deformation scenario being determined to optimize said at least one speed parameter for at least one “additional” slowed-down tooth model, different from the slowed-down tooth model(s) of said prior step(s) d), between the initial moment and the final moment,
the additional smoothed deformation scenario and said intermediate moments defining an orthodontic treatment plan, referred to as the “additional smoothed orthodontic treatment plan”.

10. The method according to claim 9, wherein the slowed-down tooth model in the first step d) or in an additional step d) is/are selected as a function of a criterion of utility for the dental practitioner and/or the user, preferably as a function of the risk to the user's health of applying the basic deformation scenario or the smoothed orthodontic treatment plan of the preceding step d), respectively.

11. The method according to claim 1, comprising, after step c), the following step e):
e) designing and manufacturing at least one orthodontic appliance, based on the basic orthodontic treatment plan obtained in step c).

12. The method according to claim 11, wherein
said orthodontic appliance is an orthodontic retainer and the intermediate moments are exclusively moments at which a change of orthodontic retainer is planned, or
said orthodontic appliance is an assembly comprising an orthodontic archwire and brackets for attaching said orthodontic archwire to the teeth, and the intermediate moments are exclusively moments at which a change of the archwire and/or of one or more brackets is planned.

13. The method according to claim 1, wherein said set of constraints comprises requirement constraints imposed by the user.

14. The method according to claim 1, wherein the computer displays a dynamic fillable form suitable for entering at least some of the information needed to define said set of constraints.

15. The method according to claim 1, wherein said set of constraints allows limited penetration of one tooth model into an adjacent tooth model, the limitation of said penetration being determined by the possibility of filing at least one of the teeth modeled by said tooth models in order to compensate for said penetration.

16. The method according to claim 1, wherein, in step b), the computer implements an optimization algorithm to determine a basic deformation scenario that best meets one or more requirements dictated by the user to specify the relative importance they give to the rapidness of orthodontic treatment, and/or the pain generated by orthodontic treatment, and/or comfort during orthodontic treatment, and/or the cost of orthodontic treatment, and/or the aesthetic impact of orthodontic treatment, and/or the reliability of orthodontic treatment.

17. The method according to claim 1, wherein, in step b), the computer
searches for a deformation scenario with a rough initial model having fewer than 5000 points, the rough initial model resulting from a simplification of a fine initial model having more points than the rough initial model, then
adds points to the transition models of the deformation scenario and the final model, then,
determines whether, in the rough deformation scenario wherein the transition and final models have been completed in this way, any tooth models collide in an unacceptable way, and
in the event of an unacceptable collision, adds points to the initial rough model and resumes said search with the initial rough model to which the points have been added.

18. A method for generating a plan for a complete orthodontic treatment of a dental arch of a user, the complete orthodontic treatment consisting of a succession of several partial orthodontic treatments each corresponding to a respective phase of the complete orthodontic treatment, the method comprising the following successive steps:
A′) generating or retrieving a first “start-of-phase” model representing said dental arch at an moment at the beginning of the first phase of the complete orthodontic treatment, said first model being broken down into tooth models, and
generating or retrieving a last “end-of-phase” model representing said dental arch with a desired arrangement of tooth models at the end of the final phase of the complete orthodontic treatment;
B′) determining, preferably by a computer or by a computer-assisted dental practitioner, for each phase from the first phase to the penultimate phase, a respective end-of-phase model representing said dental arch with a desired arrangement of tooth models at the end of said phase;
C′) for each phase, implementing a method according to any of the preceding claims, the initial model being the model at the start of said phase and the final model being the model at the end of said phase.

19. A non transitory computation tool into which is loaded a program comprising program code instructions for executing
steps b) and c), preferably steps a), b) and c) of the method according to claim 1, and/or
a step C′) and preferably a step A′) or B′), and preferably a step A′) and a step B′), of a method for generating a plan for a complete orthodontic treatment of a dental arch of a user the complete orthodontic treatment consisting of a succession of several partial orthodontic treatments each corresponding to a respective phase of the complete orthodontic treatment, the method comprising the following successive steps:
A′) generating or retrieving a first “start-of-phase” model representing said dental arch at an moment at the beginning of the first phase of the complete orthodontic treatment, said first model being broken down into tooth models, and
generating or retrieving a last “end-of-phase” model representing said dental arch with a desired arrangement of tooth models at the end of the final phase of the complete orthodontic treatment;
B′) determining, preferable by a computer or by a computer-assisted dental practitioner, for each phase from the first phase to the penultimate phase, a respective end-of-phase model representing said dental arch with a desired arrangement of tooth models at the end of said phase;
C′) for each phase, implementing a method according to any of the preceding claims, the initial model being the model at the start of said phase and the final model being the model at the end of said phase,
when said program is executed by said non transitory computation tool.

20. The non transitory computation tool according to claim 19, wherein the program code instructions are adapted to determine the final model from the initial model.

21. (canceled)
